(19) United States
(12) Patent Application Publication
(10) Pub. No.: US 2019/0359773 A1
(43) Pub. Date: Nov. 28, 2019

(54) METHOD FOR PRODUCING A POLYBENZAZOL POLYMER (P)

(71) Applicant: BASF SE, Ludwigshafen am Rhein (DE)

(72) Inventors: Johannes David HOECKER, Ludwigshafen (DE); Klemens MASSONNE, Ludwigshafen (DE); Marcel BRILL, Ludwigshafen (DE); Martin MERGER, Ludwigshafen (DE); Joachim RUCH, Ludwigshafen (DE); Olivier FLEISCHEL, Ludwigshafen (DE); Frank HERMANUTZ, Denkendorf (DE); Joerg UNOLD, Remseck am Neckar (DE)

(73) Assignee: BASF SE, Ludwigshafen am Rhein (DE)

(21) Appl. No.: 16/332,948

(22) PCT Filed: Sep. 5, 2017
(86) PCT No.: PCT/EP2017/072232

§ 371 Date: Mar. 13, 2019

(30) Foreign Application Priority Data
Sep. 14, 2016 (EP) 16188838.3

(51) Int. Cl. C08G 73/22; C08G 75/32; D01F 6/74

(52) U.S. Cl. CPC C08G 73/22; D01F 6/74; C08G 75/32

(57) ABSTRACT

The present invention relates to a method for producing a polybenzazole polymer (P) by reacting a reaction mixture (R_{G}) comprising at least one aromatic dicarboxylic compound of the general formula (I), at least one aromatic diamino compound of the general formula (IIa), (IIb), (IIc) and/or (IId) and also at least one ionic liquid (IL). The present invention also relates to the polybenzazole polymer (P), which is obtainable by the method according to the invention, and also to the use of the polybenzazole polymer (P), for example as fiber material.

The present invention relates to a method for producing a polybenzazole polymer (P) by reacting a reaction mixture (R_{G}) comprising at least one aromatic dicarboxylic compound of the general formula (I), at least one aromatic diamino compound of the general formula (IIa), (IIb), (IIc) and/or (IId) and also at least one ionic liquid (IL). The present invention also relates to the polybenzazole polymer (P), which is obtainable by the method according to the invention, and also to the use of the polybenzazole polymer (P), for example as fiber material.

Polybenzazole polymers represent a class of organic polymers which are used in particular as high-performance fibers and, owing to their exceptional tensile strength, even exceed glass, ceramic and carbon fibers in terms of their properties. Organic high-performance fibers such as polybenzazole polymers are increasingly used in technically demanding sectors since they are characterized by exceptionally high strengths and moduli of elasticity and by high thermal stability, flame retardance and resistance to chemicals.

In contrast to metallic materials, polymeric materials based on polybenzazole polymers are often prone to degradation processes under environmental influences which results in rapid aging and thus deterioration in the properties up to the extent that they are unusable. Due to the effect of external environmental influences such as UV radiation and moisture, rapid degradation takes place, whereby ultimately the mechanical properties and particularly the tensile strength are significantly diminished. Due to rapid aging, materials based on polybenzazole polymers must either be exchanged after a brief time or be protected from environmental influences in an appropriate manner by composite construction with more resistant materials. Although aging can be slowed by sheathing, the low aging resistance prevents universal usability of materials based on polybenzazole polymers to a few special sectors.

The production of polybenzazole polymers is known and is described in the prior art: For instance, “Kumar et al., Rigid-Rod Polymeric Fibers, Journal of Applied Polymer Science, Vol. 100, 791-802 (2006)” discloses the production of polybenzazole polymers from terephthalic acid and an aromatic diamino compound having two further substituents, wherein the two further substituents can be amino groups, hydroxyl groups or thiol groups. These starting compounds are reacted in this case in the presence of polyphosphoric acid, which serves simultaneously as solvent, catalyst and water-extracting agent. As an alternative, methanesulfonic acid, chlorosulfonic acid or trifluoroacetic acid can also be used as solvent in place of polyphosphoric acid. The use of these acids is stated to be advantageous particularly since, by means of their use, polybenzazole polymers can be produced in situ without further separation processes.

U.S. Pat. No. 5,089,591 likewise describes a method for producing polybenzazole polymers by reacting polybenzazole oligomers dissolved in an acid at temperatures above 150° C. and a shear rate of at least 10 sec⁻¹. Acids suitable as solvents in this case are sulfuric acid, methanesulfonic acid, trifluoromethanesulfonic acid and polyphosphoric acid.

US 2001/003130 A1 discloses a method for producing polybenzazoleoyl benzazoles, which are obtained by reacting aromatic dicarboxylates with disubstituted aromatic diamino compounds, wherein the two further substituents can be hydroxyl groups, thiol groups or amino groups. The synthesis of polybenzazoleoyl benzazoles disclosed in US 2001/0003130 A1 is carried out in the presence of polyphosphoric acid and phosphorus pentoxide.

CN 103 880 767 describes a method for producing a polybenzazole polymer. In this case, terephthaloyl dichloride and 4,6-diaminoresorcinol (4,6-diamino-1,3-dihydroxybenzene) are reacted in a strongly hydrophobic ionic liquid in a first step, wherein a condensation product is obtained consisting of exactly one molecule of terephthaloyl dichloride and exactly one molecule of 4,6-diaminoresorcinol. To produce the polybenzazole polymer, this condensation product is reacted in a second step in phosphoric acid and phosphorus pentoxide.

The use of acids used hitherto for the synthesis of polybenzazole polymers has proved disadvantageous however, since these acids cannot be completely removed from the polybenzazole polymer after the production process and therefore always remain in low concentrations in the polymer matrix. Under the influence of moisture, these acid residues initiate hydrolysis of the polymer chains. This degradation is significantly accelerated by the effect of UV.

For instance, “Holmes et al., The Effect of Environmental and Mechanical Mechanisms on the Performance of Soft Body Armor, 2009, Analytical Chemistry Division, ICCM International Conferences on Composite Materials 01/2009”, discloses that the lack of stability to hydrolysis of benzoxazole rings is due to low residual contents of phosphoric acid from the production process of polybenzoxazole. The phosphoric acid can be present here as free phosphoric acid or in the form of aryl phosphate esters, which are bonded to polybenzoxazole, in which the aryl phosphate esters slowly hydrolyze in the present of water and form phosphoric acid.

“Chin et al., Temperature and humidity aging of poly(p-phenylene-2,6-benzo-bisoxazole) fibers: Chemical and physical characterization, Polymer Degradation and Stability, 92, 1234-1246 (2007)” discloses that the sensitivity of polybenzoxazole polymers to hydrolysis or elevated temperatures is due to polyphosphoric acid residues, which results in opening of the benzoxazole rings and thus to polymer degradation.

The object of the present invention therefore consists of providing an improved production process for polybenzazole polymers which can be carried out without the acids used in the prior art. With the improved process, it is intended that polybenzazole polymers can be provided which possess improved aging resistance.

This object is achieved by a method for producing a polybenzazole polymer (P) by reacting a reaction mixture (R_{G}) comprising the following components:
(a) at least one aromatic dicarboxylic compound of the general formula (I),

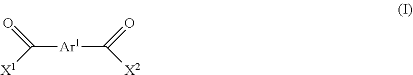

in which
Ar¹ is selected from the group consisting of unsubstituted or at least monosubstituted phenylene, naphthalenediyl, anthracenediyl, biphenyldiyl, diphenylmethanediyl, diphenyl etherdiyl, diphenylthio etherdiyl, diphenyl sulfonediyl, benzophenonediyl, pyridinediyl, pyrimidinediyl, furandiyl and thiophenediyl,
   wherein the substituents are selected from the group consisting of —F, —Cl, —Br, —OR¹ and —C₁-C₁₀-alkyl,
   wherein R¹ is —H or —C₁-C₁₀-alkyl;
X¹, X² are each independently selected from the group consisting of —OR², —F, —Cl and —Br,
   wherein R² is —H, —C₁-C₁₀-alkyl, —C₁-C₁₀-alkenyl or a repeating unit of the general formula (Ia):

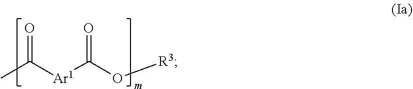

in which
m is a natural number from 1 to 50, and
R³ is —H, —C₁-C₁₀-alkyl or —C₁-C₁₀-alkenyl;
(b) at least one aromatic diamino compound of the general formula (IIa), (IIb), (IIc) and/or (IId):

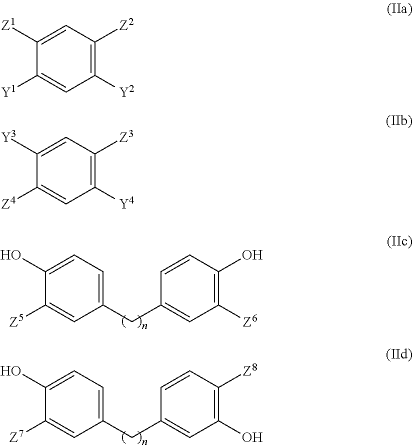

in which
n is 0 or 1
Y¹, Y², Y³, Y⁴ are each independently —H, —OR⁴ or —SR⁴,
wherein R⁴ is selected from the group consisting of —H, —C₁-C₁₀-alkyl, trimethylsilyl, tert-butyldimethylsilyl, acetyl and tert-butyloxycarbonyl, and
wherein at most one of the radicals Y¹ and Y² is —H, and
wherein at most one of the radicals Y³ and Y⁴ is —H;
Z¹, Z², Z³, Z⁴, Z⁵, Z⁶, Z⁷, Z⁸ are each independently —NH₂ or —NH₃⁺Q⁻,
wherein Q⁻ is an anion equivalent selected from the group consisting of F⁻, Cl⁻, Br⁻, I⁻, HSO₄⁻, SO₄²⁻, H₃C—SO₃⁻, p-H₃C—C₆H₄—SO₃⁻ and NO₃⁻;
and
(c) at least one ionic liquid (IL);
   to obtain a product mixture (P_{G}) comprising the polybenzazole polymer (P) and the at least one ionic liquid (IL).

Surprisingly, it has been found that ionic liquids are suitable as solvent for the production of polybenzazole polymers (P) such that the acids used in the methods disclosed in the prior art are not required. The polybenzazole polymers (P) obtained in the presence of ionic liquids thereby have increased resistance to aging processes and external environmental influences.

Through the use of ionic liquids, complex separation and purification processes for removing acid esters from the polybenzazole polymer are not required such that a more environmentally friendly and cost-effective process regime is enabled. Due to the reusability of the ionic liquids in the production of the polybenzazole polymers (P), a significant improvement of the process regime is achieved compared to the methods disclosed in the prior art.

By using ionic liquids, it is further possible to obtain polybenzazole polymers (P) having high molecular weights.

The present invention is elucidated in detail hereinbelow.

The polybenzazole polymer (P) is obtained in the method according to the invention by reacting a reaction mixture (R_{G}) to obtain a product mixture (P_{G}) comprising the polybenzazole polymer (P).

Polybenzazole polymers are a class of polymers which are known in principle to those skilled in the art. In the context of the present invention, “polybenzazole polymer (P)” is understood to mean a polymer comprising repeating units of polybenzoxazole and/or polybenzothiazole.

In the context of the present invention, the term “polybenzoxazole” refers to polymers comprising repeating units of oxazole rings and aromatic groups. The aromatic groups in this case are not necessarily benzene rings.

In the context of the present invention, the term “polybenzothiazole” refers to polymers comprising repeating units of thiazole rings and aromatic groups. The aromatic groups in this case are not necessarily benzene rings.

The reaction mixture (R_{G}) is the mixture which is reacted to produce the polybenzazole polymer (P).

The reaction mixture (R_{G}) comprises as components at least one aromatic dicarboxylic compound of the general formula (I) (component (a)), at least one aromatic diamino compound of the general formula (IIa), (IIb), (IIc) and/or (IId) (component (b)) and at least one ionic liquid (IL) (component (c)).

Components (a) and (b) are preferably at least partially dissolved in component (c). Preferably at least 60% by weight, particularly preferably at least 80% by weight of components (a) and (b) are dissolved in component (c), based on the total weight of components (a) and (b) in the reaction mixture (R_{G}). Especially preferably, components (a) and (b) are dissolved completely in component (c).

The expression “dissolved completely” signifies here that preferably at most 5% by weight, preferably at most 3% by weight, more preferably at most 2% by weight and particularly preferably at most 1% by weight of components (a) and (b) are present as solid particles in component (c), based on the total weight of components (a) and (b) in the reaction mixture (R_{G}). Very particularly preferably, component (c) comprises absolutely no solid particles of components (a) and (b). Consequently, components (a) and (b) very particularly preferably cannot be separated by filtration from component (c).

Components (a) and (b) can be dissolved in component (c) by all methods known to those skilled in the art. Preferably, components (a) and (b) are dissolved in component (c) with stirring. Components (a) and (b) can be dissolved in component (c) simultaneously or successively.

Components (a) and (b) are dissolved in component (c) preferably at elevated temperatures, preferably in the range from 20 to 120° C. and particularly preferably in the range from 40 to 100° C.

Components (a) and (b) react with each other in the method according to the invention in the presence of component (c) in a polycondensation reaction. Component (c) serves as solvent and preferably does not copolymerize here with components (a) and (b). In the event that a portion of component (c) copolymerizes with components (a) and (b), preferably at most 1% by weight, particularly preferably at most 0.5% by weight of component (c), based on the total weight of component (c), copolymerizes with components (a) and (b). Very particularly preferably, component (c) does not copolymerize at all with components (a) and (b).

In one embodiment, the polybenzazole polymer (P) according to the invention is obtained by reacting the reaction mixture (R_{G}) in the presence of at least one basic compound. The at least one basic compound may in principle be any basic compound known to those skilled in the art. It is preferable when the at least one basic compound is a basic alkali metal or alkaline earth metal compound. The at least one basic compound is particularly preferably selected from the group consisting of lithium hydroxide, sodium hydroxide, potassium hydroxide, magnesium hydroxide, calcium hydroxide, barium hydroxide, lithium carbonate, sodium carbonate, potassium carbonate, magnesium carbonate, calcium carbonate, lithium hydride, sodium hydride, potassium hydride, magnesium hydride and calcium hydride. The at least one basic compound (B) is very particularly preferably selected from the group consisting of sodium carbonate, potassium carbonate, lithium hydride, sodium hydride, magnesium hydride and calcium hydride.

The present invention therefore also further relates to a method, characterized in that the reaction mixture (R_{G}) is reacted in the presence of at least one basic compound selected from the group consisting of lithium hydroxide, sodium hydroxide, potassium hydroxide, magnesium hydroxide, calcium hydroxide, barium hydroxide, lithium carbonate, sodium carbonate, potassium carbonate, magnesium carbonate, calcium carbonate, lithium hydride, sodium hydride, potassium hydride, magnesium hydride and calcium hydride.

The reaction mixture (R_{G}) can also be reacted in the presence of at least one inorganic salt which differs from the at least one basic compound defined above. The at least one inorganic salt can in principle be any inorganic salt known to those skilled in the art and can be precisely one inorganic salt and mixtures of two or more different inorganic salts. The at least one inorganic salt is preferably an alkali metal, alkaline earth metal, aluminum, tin(II), iron(II) or manganese(II) salt. The at least one inorganic salt is more preferably an alkali metal, alkaline earth metal, aluminum, tin(II), iron(II) or manganese(II) halide. The at least one inorganic salt is particularly preferably selected from the group consisting of lithium chloride, lithium bromide, lithium iodide, sodium chloride, sodium bromide, sodium iodide, potassium chloride, potassium bromide, potassium iodide, magnesium chloride, magnesium bromide, magnesium iodide, calcium chloride, calcium bromide, calcium iodide, barium chloride, barium bromide, barium iodide, aluminum chloride, aluminum bromide, aluminum iodide, tin(II) chloride, tin(II) bromide, tin(II) iodide, iron(II) chloride, iron(II) bromide, iron(II) iodide, manganese(II) chloride, manganese(II) bromide and manganese(II) iodide. The at least one inorganic salt is very particularly preferably selected from the group consisting of lithium chloride, sodium chloride, potassium chloride, magnesium chloride, calcium chloride, aluminium chloride, tin(II) chloride, iron(II) chloride and manganese(II) chloride.

The polycondensation reaction may in principle be carried out at any desired temperature. The polycondensation reaction is preferably carried out at a temperature in the range from 30 to 220° C., preferably in the range from 60 to 200° C. and particularly preferably in the range from 80 to 180° C.

Volatile by-products may form during the polycondensation reaction which are preferably already removed continuously during the reaction of the reaction mixture (R_{G}). In the context of the present invention, “volatile by-products” are understood to mean all compounds formed in the reaction of the reaction mixture (R_{G}) having a boiling point below 200° C., preferably below 150° C. and particularly preferably below 120° C. Preferred volatile by-products comprise, for example, water (water of reaction) or hydrogen halides. The volatile by-products can in principle be removed by all methods known to those skilled in the art. In a preferred embodiment, the volatile by-products are distilled off continuously during the reaction of the reaction mixture (R_{G}), optionally with continuously supply of a nitrogen stream.

All figures below relating to the reaction mixture (R_{G}) refer to the mixture prior to carrying out the polycondensation reaction. In the polycondensation reaction, the reaction mixture (R_{G}) is converted to the product mixture (P_{G}) comprising the polybenzazole polymer (P) and the at least one ionic liquid (IL).

Therefore, the product mixture (P_{G}) is the mixture which is present after carrying out the polycondensation reaction. Consequently, all figures relating to the product mixture (P_{G}) refer to the mixture after carrying out the polycondensation reaction.

The reaction mixture (R_{G}) preferably comprises 5% by weight to 25% by weight component (a), 5% by weight to 25% by weight component (b) and 50% by weight to 90% by weight component (c), based on the total weight of the reaction mixture (R_{G}).

The present invention therefore further relates to a method, characterized in that the reaction mixture (R_{G}) comprises 5 to 25% by weight of component (a), 5 to 25% by weight of component (b) and 50 to 90% by weight of component (c), based on the total weight of the reaction mixture (R_{G}).

The reaction mixture (R_{G}) preferably comprises 8% by weight to 18% by weight component (a), 8% by weight to 18% by weight component (b) and 64% by weight to 84% by weight component (c), based on the total weight of the reaction mixture (R_{G}) and particularly preferably the reaction mixture (R_{G}) comprises 10% by weight to 15% by weight component (a), 10% by weight to 15% by weight component (b) and 70% by weight to 80% by weight component (c), based on the total weight of the reaction mixture (R_{G}).

In a particular embodiment, the reaction mixture (R_{G}) comprises additionally at least one linear or branched aliphatic dicarboxylic compound as comonomer. The at least one linear or branched aliphatic dicarboxylic compound preferably comprises 2 to 20 carbon atoms. Particularly preferred linear or branched aliphatic dicarboxylic compounds are oxalic acid, malonic acid, succinic acid, glutaric acid, adipic acid, pimelic acid, suberic acid, azelaic acid, sebacic acid and branched isomers thereof.

In the case that the reaction mixture comprises at least one linear or branched aliphatic dicarboxylic compound, the reaction mixture (R_{G}) preferably comprises 3 to 15% by weight component (a), 5 to 25% by weight component (b), 50 to 90% by weight component (c) and 2 to 10% by weight of the at least one linear or branched aliphatic dicarboxylic compound, based on the total weight of the reaction mixture (R_{G}). The total weight of all components in the reaction mixture (R_{G}) generally adds up to 100% by weight.

The product mixture (P_{G}) preferably comprises at least 5% by weight of the polybenzazole polymer (P), based on the total weight of the product mixture (P_{G}). The product mixture (P_{G}) particularly preferably comprises at least 10% by weight and very particularly preferably at least 12% by weight of the polybenzazole polymer (P), based on the total weight of the product mixture (P_{G}).

Furthermore, the product mixture (P_{G}) preferably comprises at most 25% by weight of the polybenzazole polymer (P), based on the total weight of the product mixture (P_{G}). The product mixture (P_{G}) particularly preferably comprises at most 22% by weight and very particularly preferably at most 20% by weight of the polybenzazole polymer (P), based on the total weight of the product mixture (P_{G}).

The product mixture (P_{G}) preferably comprises 5% by weight to 25% by weight, preferably 10% by weight to 22% by weight and particularly preferably 12% by weight to 20% by weight of the polybenzazole polymer (P), based on the total weight of the product mixture (P_{G}).

The polybenzazole polymer (P) is preferably at least partially dissolved in the at least one ionic liquid (IL). Preferably at least 40% by weight, particularly preferably at least 60% by weight and very particularly preferably at least 80% by weight of the polybenzazole polymer (P) is dissolved in the at least one ionic liquid (IL), based on the total weight of the polybenzazole polymer (P) in the product mixture (P_{G}). Very particularly preferably, the polybenzazole polymer (P) is dissolved completely in the at least one ionic liquid (IL).

The present invention therefore also further relates to a method, characterized in that at least 40% by weight of the polybenzazole polymer (P) is dissolved in the at least one ionic liquid (IL), based on the total weight of the polybenzazole polymer (P) in the product mixture (P_{G}).

The expression “dissolved completely” signifies here that preferably at most 5% by weight, preferably at most 3% by weight, more preferably at most 2% by weight and particularly preferably at most 1% by weight of the polybenzazole polymer (P) are present as solid particles in the at least one ionic liquid (IL), based on the total weight of the polybenzazole polymer (P) in the product mixture (P_{G}). Very particularly preferably, the at least one ionic liquid (IL) comprises absolutely no solid particles of the polybenzazole polymer (P). Consequently, the polybenzazole polymer (P) very particularly preferably cannot be separated by filtration from the at least one ionic liquid (IL).

The polybenzazole polymer (P) can be separated from the product mixture (P_{G}) by all methods known to those skilled in the art. For example, the polybenzazole polymer (P) can be precipitated from the product mixture (P_{G}) by adding a suitable precipitant.

Suitable precipitants are known in principle to those skilled in the art and preferably include protic polar solvents such as water, methanol, ethanol, n-propanol, isopropanol, glycerol, ethylene glycol or mixtures thereof.

The components (a), (b) and (c) are elucidated in detail hereinafter.

Component (a)

The reaction mixture (R_{G}) comprises at least one aromatic dicarboxylic compound of the general formula (I) as component (a).

The expressions “component (a)”, “at least one aromatic dicarboxylic compound of the general formula (I)” and “at least one aromatic dicarboxylic compound (I)” are used synonymously hereinbelow.

The expression “at least one aromatic dicarboxylic compound of the general formula (I)” refers here precisely to one aromatic dicarboxylic compound of the general formula (I) and also to mixtures of two or more different aromatic dicarboxylic compounds of the general formula (I). Suitable aromatic dicarboxylic compounds of the general formula (I) are known in principle to those skilled in the art.

The at least one aromatic dicarboxylic compound used in the method according to the invention has the general formula (I):

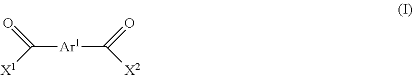

in which
Ar¹ is selected from the group consisting of unsubstituted or at least monosubstituted phenylene, naphthalenediyl, anthracenediyl, biphenyldiyl, diphenylmethanediyl, diphenyl etherdiyl, diphenylthio etherdiyl, diphenyl sulfonediyl, benzophenonediyl, pyridinediyl, pyrimidinediyl, furandiyl and thiophenediyl,
   wherein the substituents are selected from the group consisting of —F, —Cl, —Br, —OR¹ and —C₁-C₁₀-alkyl,
   wherein R¹ is —H or —C₁-C₁₀-alkyl;
X¹, X² are each independently selected from the group consisting of —OR², —F, —Cl and —Br,
   wherein R² is —H, —C₁-C₁₀-alkyl, —C₁-C₁₀-alkenyl or a repeating unit of the general formula (Ia):

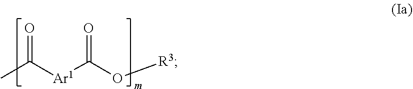

in which
m is a natural number from 1 to 50, and
R³ is —H, —C₁-C₁₀-alkyl or —C₁-C₁₀-alkenyl.

The at least one aromatic dicarboxylic compound of the general formula (I) used in the method according to the invention preferably comprises two functional groups which are each independently selected from the group consisting of carboxylic groups (—CO₂H), carbonyl fluorides (—COF), carbonyl chlorides (—OCl), carbonyl bromides (—COBr), carboxylic esters (—CO₂R², in which R² is a C₁-C₁₀-alkyl group or a C₁-C₁₀-alkenyl group) and carboxylic anhydrides (—CO₂R², in which R² is a repeating unit of the general formula (Ia) defined above).

Ar¹ in the method according to the invention is selected from the group consisting of unsubstituted or at least monosubstituted phenylene, naphthalenediyl, anthracenediyl, biphenyldiyl, diphenylmethanediyl, diphenyl etherdiyl, diphenylthio etherdiyl, diphenyl sulfonediyl, benzophenonediyl, pyridinediyl, pyrimidinediyl, furandiyl and thiophenediyl. Relevant suitable aromatic dicarboxylic compounds of the general formula (I) are known in principle to those skilled in the art. In principle, all appropriate aromatic dicarboxylic compounds of the general formula (I) known to those skilled in the art can be used in the method according to the invention.

For the radical Ar¹, suitable unsubstituted or at least monosubstituted phenylene groups are selected, for example, from the group consisting of 1,2-phenylene, 1,3-phenylene and 1,4-phenylene, preferably 1,4-phenylene. The phenylene groups are preferably unsubstituted. Relevant aromatic dicarboxylic compounds (I) having a phenylene group as radical Ar¹ include, for example, phthalic acid, isophthalic acid, terephthalic acid, phthalic anhydride, phthaloyl difluoride, phthaloyl dichloride, phthaloyl dibromide, isophthalic anhydride, isophthaloyl difluoride, isophthaloyl dichloride, isophthaloyl dibromide, terephthalic anhydride, terephthaloyl difluoride, terephthaloyl dichloride, terephthaloyl dibromide, polyanhydrides of phthalic acid, polyanhydrides of isophthalic acid, polyanhydrides of terephthalic acid and also C₁-C₁₀-alkyl esters of phthalic acid, isophthalic acid and terephthalic acid and C₁-C₁₀-alkenyl esters of phthalic acid, isophthalic acid and terephthalic acid.

For the radical Ar¹, suitable unsubstituted or at least monosubstituted naphthalenediyl groups are, for example, selected from the group consisting of naphthalene-1,4-diyl, naphthalene-1,5-diyl, naphthalene-2,6-diyl and naphthalene-2,7-diyl, preferably naphthalene-1,4-diyl and naphthalene-2,6-diyl. The naphthalene groups are preferably unsubstituted. Appropriate aromatic dicarboxylic compounds (I) having a naphthalenediyl group as radical Ar¹ include, for example, naphthalene-1,4-dicarboxylic acid, naphthalene-1,5-dicarboxylic acid, naphthalene-2,6-dicarboxylic acid, naphthalene-2,7-dicarboxylic acid, naphthalene-1,4-dicarboxylic anhydride, naphthalene-1,4-dicarbonyl difluoride, naphthalene-1,4-dicarbonyl dichloride, naphthalene-1,4-dicarbonyl dibromide, naphthalene-1,5-dicarboxylic anhydride, naphthalene-1,5-dicarbonyl difluoride, naphthalene-1,5-dicarbonyl dichloride, naphthalene-1,5-dicarbonyl dibromide, naphthalene-2,6-dicarboxylic anhydride, naphthalene-2,6-dicarbonyl difluoride, naphthalene-2,6-dicarbonyl dichloride, naphthalene-2,6-dicarbonyl dibromide, naphthalene-2,7-dicarboxylic anhydride, naphthalene-2,7-dicarbonyl difluoride, naphthalene-2,7-dicarbonyl dichloride, naphthalene-2,7-dicarbonyl dibromide, polyanhydrides of naphthalene-1,4-dicarboxylic acid, polyanhydrides of naphthalene-1,5-dicarboxylic acid, polyanhydrides of naphthalene-2,6-dicarboxylic acid, polyanhydrides of naphthalene-2,7-dicarboxylic acid and also C₁-C₁₀-alkyl esters of naphthalene-1,4-dicarboxylic acid, naphthalene-1,5-dicarboxylic acid, naphthalene-2,6-dicarboxylic acid and naphthalene-2,7-dicarboxylic acid and C₁-C₁₀-alkenyl esters of naphthalene-1,4-dicarboxylic acid, naphthalene-1,5-dicarboxylic acid, naphthalene-2,6-dicarboxylic acid and naphthalene-2,7-dicarboxylic acid.

For the radical Ar¹, suitable unsubstituted or at least monosubstituted anthracenediyl groups are, for example, selected from the group consisting of anthracene-1,4-diyl, anthracene-1,5-diyl, anthracene-2,6-diyl and anthracene-9,10-diyl, preferably anthracene-2,6-diyl and anthracene-9,10-diyl. The anthracene groups are preferably unsubstituted. Appropriate aromatic dicarboxylic compounds (I) having an anthracenediyl group as radical Ar¹ include, for example, anthracene-1,4-dicarboxylic acid, anthracene-1,5-dicarboxylic acid, anthracene-2,6-dicarboxylic acid, anthracene-9,10-dicarboxylic acid, anthracene-1,4-dicarbonyl difluoride, anthracene-1,4-dicarboxylic anhydride, anthracene-1,4-dicarbonyl dichloride, anthracene-1,4-dicarbonyl dibromide, anthracene-1,5-dicarboxylic anhydride, anthracene-1,5-dicarbonyl difluoride, anthracene-1,5-dicarbonyl dichloride, anthracene-1,5-dicarbonyl dibromide, anthracene-2,6-dicarboxylic anhydride, anthracene-2,6-dicarbonyl difluoride, anthracene-2,6-dicarbonyl dichloride, anthracene-2,6-dicarbonyl dibromide, anthracene-9,10-dicarboxylic anhydride, anthracene-9,10-dicarbonyl difluoride, anthracene-9,10-dicarbonyl dichloride, anthracene-9,10-dicarbonyl dibromide, polyanhydrides of anthracene-1,4-dicarboxylic acid, polyanhydrides of anthracene-1,5-dicarboxylic acid, polyanhydrides of anthracene-2,6-dicarboxylic acid, polyanhydrides of anthracene-9,10-dicarboxylic acid and also C₁-C₁₀-alkyl esters of anthracene-1,4-dicarboxylic acid, anthracene-1,5-dicarboxylic acid, anthracene-2,6-dicarboxylic acid and anthracene-9,10-dicarboxylic acid and C₁-C₁₀-alkenyl esters of anthracene-1,4-dicarboxylic acid, anthracene-1,5-dicarboxylic acid, anthracene-2,6-dicarboxylic acid and anthracene-9,10-dicarboxylic acid.

For the radical Ar¹, suitable unsubstituted or at least monosubstituted biphenyldiyl groups are, for example, selected from the group consisting of biphenyl-3,3′-diyl and biphenyl-4,4′-diyl, preferably biphenyl-4,4′-diyl. The biphenyldiyl groups are preferably unsubstituted. Appropriate aromatic dicarboxylic compounds having a biphenyldiyl group as radical Ar¹ include, for example, biphenyl-3,3′-dicarboxylic acid, biphenyl-4,4′-dicarboxylic acid, biphenyl-3,3′-dicarboxylic anhydride, biphenyl-3,3′-dicarbonyl difluoride, biphenyl-3,3′-dicarbonyl dichloride, biphenyl-3,3′-dicarbonyl dibromide, biphenyl-4,4′-dicarboxylic anhydride, biphenyl-4,4′-dicarbonyl difluoride, biphenyl-4,4′-dicarbonyl dichloride, biphenyl-4,4′-dicarbonyl dibromide, polyanhydrides of biphenyl-3,3′-dicarboxylic acid, polyanhydrides of biphenyl-4,4′-dicarboxylic acid and also C₁-C₁₀-alkyl esters of biphenyl-3,3′-dicarboxylic acid and biphenyl-4,4′-dicarboxylic acid and C₁-C₁₀-alkenyl esters of biphenyl-3,3′-dicarboxylic acid and biphenyl-4,4′-dicarboxylic acid.

For the radical Ar¹, suitable unsubstituted or at least monosubstituted diphenylmethanediyl groups are, for example, selected from the group consisting of diphenylmethane-3,3′-diyl and diphenylmethane-4,4′-diyl, preferably diphenylmethane-4,4′-diyl. The diphenylmethanediyl groups are preferably unsubstituted. Appropriate aromatic dicarboxylic compounds (I) having a diphenylmethanediyl group as radical Ar¹ include, for example, diphenylmethane-3,3′-dicarboxylic acid, diphenylmethane-4,4′-dicarboxylic acid, diphenylmethane-3,3′-dicarboxylic anhydride, diphenylmethane-3,3′-dicarbonyl difluoride, diphenylmethane-3,3′-dicarbonyl dichloride, diphenylmethane-3,3′-dicarbonyl dibromide, diphenylmethane-4,4′-dicarboxylic anhydride diphenylmethane-4,4′-dicarbonyl difluoride, diphenylmethane-4,4′-dicarbonyl dichloride, diphenylmethane-4,4′-dicarbonyl dibromide, polyanhydrides of diphenylmethane-3,3′-dicarboxylic acid, polyanhydrides of diphenylmethane-4,4′-dicarboxylic acid and also C₁-C₁₀-alkyl esters of diphenylmethane-3,3′-dicarboxylic acid and diphenylmethane-4,4′-dicarboxylic acid and C₁-C₁₀-alkenyl esters of diphenylmethane-3,3′-dicarboxylic acid and diphenylmethane-4,4′-dicarboxylic acid.

For the radical Ar¹, suitable unsubstituted or at least monosubstituted diphenyl ether diyl groups are, for example, selected from the group consisting of diphenyl ether 3,3′-diyl and diphenyl ether 4,4′-diyl, preferably diphenyl ether 4,4′-diyl. The diphenyl ether diyl groups are preferably unsubstituted. Appropriate aromatic dicarboxylic compounds (I) having a diphenyl ether diyl group as radical Ar¹ include, for example, diphenyl ether 3,3′-dicarboxylic acid, diphenyl ether 4,4′-dicarboxylic acid, diphenyl ether 3,3′-dicarboxylic anhydride, diphenyl ether 3,3′-dicarbonyl difluoride, diphenyl ether 3,3′-dicarbonyl dichloride, diphenyl ether 3,3′-dicarbonyl dibromide, diphenyl ether 4,4′-dicarboxylic anhydride, diphenyl ether 4,4′-dicarbonyl difluoride, diphenyl ether 4,4′-dicarbonyl dichloride, diphenyl ether 4,4′-dicarbonyl dibromide, polyanhydrides of diphenyl ether 3,3′-dicarboxylic acid, polyanhydrides of diphenyl ether 4,4′-dicarboxylic acid and also C₁-C₁₀-alkyl esters of diphenyl ether 3,3′-dicarboxylic acid and diphenyl ether 4,4′-dicarboxylic acid and C₁-C₁₀-alkenyl esters of diphenyl ether 3,3′-dicarboxylic acid and diphenyl ether 4,4′-dicarboxylic acid.

For the radical Ar¹, suitable unsubstituted or at least monosubstituted diphenyl thioether diyl groups are, for example, selected from the group consisting of diphenyl thioether 3,3′-diyl and diphenyl ether 4,4′-diyl, preferably diphenyl ether 4,4′-diyl. The diphenyl thioether diyl groups are preferably unsubstituted. Appropriate aromatic dicarboxylic compounds (I) having a diphenyl thioether diyl group as radical Ar¹ include, for example, diphenyl thioether 3,3′-dicarboxylic acid, diphenyl thioether 4,4′-dicarboxylic acid, diphenyl thioether 3,3′-dicarbonyl difluoride, diphenyl thioether 3,3′-dicarboxylic anhydride, diphenyl thioether 3,3′-dicarbonyl dichloride, diphenyl thioether 3,3′-dicarbonyl dibromide, diphenyl thioether 4,4′-dicarboxylic anhydride diphenyl thioether 4,4′-dicarbonyl difluoride, diphenyl thioether 4,4′-dicarbonyl dichloride, diphenyl thioether 4,4′-dicarbonyl dibromide, polyanhydrides of diphenyl thioether 3,3′-dicarboxylic acid, polyanhydrides of diphenyl thioether 4,4′-dicarboxylic acid and also C₁-C₁₀-alkyl esters of diphenyl thioether 3,3′-dicarboxylic acid and diphenyl thioether 4,4′-dicarboxylic acid and C₁-C₁₀-alkenyl esters of diphenyl thioether 3,3′-dicarboxylic acid and diphenyl thioether 4,4′-dicarboxylic acid.

For the radical Ar¹, suitable unsubstituted or at least monosubstituted diphenyl sulfone diyl groups are, for example, selected from the group consisting of diphenyl sulfone 3,3′-diyl and diphenyl sulfone 4,4′-diyl, preferably diphenyl sulfone 4,4′-diyl. The diphenyl sulfone diyl groups are preferably unsubstituted. Appropriate aromatic dicarboxylic compounds (I) having a diphenyl sulfone diyl group as radical Ar¹ include, for example, diphenyl sulfone 3,3′-dicarboxylic acid, diphenyl sulfone 4,4′-dicarboxylic acid, diphenyl sulfone 3,3′-dicarboxylic anhydride, diphenyl sulfone 3,3′-dicarbonyl difluoride, diphenyl sulfone 3,3′-dicarbonyl dichloride, diphenyl sulfone 3,3′-dicarbonyl dibromide, diphenyl sulfone 4,4′-dicarboxylic acid, diphenyl sulfone 4,4′-dicarbonyl difluoride, diphenyl sulfone 4,4′-dicarbonyl dichloride, diphenyl sulfone 4,4′-dicarbonyl dibromide, polyanhydrides of diphenyl sulfone 3,3′-dicarboxylic acid, polyanhydrides of diphenyl sulfone 4,4′-dicarboxylic acid and also C₁-C₁₀-alkyl esters of diphenyl sulfone 3,3′-dicarboxylic acid and diphenyl sulfone 4,4′-dicarboxylic acid and C₁-C₁₀-alkenyl esters of diphenyl sulfone 3,3′-dicarboxylic acid and diphenyl sulfone 4,4′-dicarboxylic acid.

For the radical Ar¹, suitable unsubstituted or at least monosubstituted benzophenonediyl groups are, for example, selected from the group consisting of benzophenone-3,3′-diyl and benzophenone-4,4′-diyl, preferably benzophenone-4,4′-diyl. The benzophenonediyl groups are preferably unsubstituted. Appropriate aromatic dicarboxylic compounds (I) having a benzophenonediyl group as radical Ar¹ include, for example, benzophenone-3,3′-dicarboxylic acid, benzophenone-4,4′-dicarboxylic acid, benzophenone-3,3′-dicarboxylic anhydride, benzophenone-3,3′-dicarbonyl difluoride, benzophenone-3,3′-dicarbonyl dichloride, benzophenone-3,3′-dicarbonyl dibromide, benzophenone-4,4′-dicarboxylic anydride, benzophenone-4,4′-dicarbonyl difluoride, benzophenone-4,4′-dicarbonyl dichloride, benzophenone-4,4′-dicarbonyl dibromide, polyanhydrides of benzophenone-3,3′-dicarboxylic acid, polyanhydrides of benzophenone-4,4′-dicarboxylic acid and also C₁-C₁₀-alkyl esters of benzophenone-3,3′-dicarboxylic acid and benzophenone-4,4′-dicarboxylic acid and C₁-C₁₀-alkenyl esters of benzophenone-3,3′-dicarboxylic acid and benzophenone-4,4′-dicarboxylic acid.

For the radical Ar¹, suitable unsubstituted or at least monosubstituted pyridinediyl groups are, for example, selected from the group consisting of pyridine-2,5-diyl, pyridine-2,6-diyl and pyridine-3,5-diyl, preferably pyridine-2,5-diyl. The pyridinediyl groups are preferably unsubstituted. Appropriate aromatic dicarboxylic compounds (I) having a pyridinediyl group as radical Ar¹ include, for example, pyridine-2,5-dicarboxylic acid, pyridine-2,6-dicarboxylic acid, pyridine-3,5-carboxylic acid, pyridine-2,5-dicarboxylic anhydride, pyridine-2,5-dicarbonyl difluoride, pyridine-2,5-dicarbonyl dichloride, pyridine-2,5-dicarbonyl dibromide, pyridine-2,6-dicarboxylic anhydride, pyridine-2,6-dicarbonyl difluoride, pyridine-2,6-dicarbonyl dichloride, pyridine-2,6-dicarbonyl dibromide, pyridine-3,5-dicarboxylic anhydride, pyridine-3,5-dicarbonyl difluoride, pyridine-3,5-dicarbonyl dichloride, pyridine-3,5-dicarbonyl dibromide, polyanhydrides of pyridine-2,5-dicarboxylic acid, polyanhydrides of pyridine-2,6-dicarboxylic acid, polyanhydrides of pyridine-3,5-dicarboxylic acid and also C₁-C₁₀-alkyl esters of pyridine-2,5-dicarboxylic acid, pyridine-2,6-dicarboxylic acid and pyridine-3,5-dicarboxylic acid and C₁-C₁₀-alkenyl esters of pyridine-2,5-dicarboxylic acid, pyridine-2,6-dicarboxylic acid and pyridine-3,5-dicarboxylic acid.

For the radical Ar¹, suitable unsubstituted or at least monosubstituted pyrimidinediyl groups are, for example, selected from the group consisting of pyrimidine-2,4-diyl, pyrimidine-2,5-diyl and pyrimidine-4,6-diyl, preferably pyrimidine-4,6-diyl. The pyrimidinediyl groups are preferably unsubstituted. Appropriate aromatic dicarboxylic compounds (I) having a pyrimidinediyl group as radical Ar¹ include, for example, pyrimidine-2,4-dicarboxylic acid, pyrimidine-2,5-dicarboxylic acid, pyrimidine-4,6-dicarboxylic acid, pyrimidine-2,4-dicarboxylic anhydride, pyrimidine-2,4-dicarbonyl difluoride, pyrimidine-2,4-dicarbonyl dichloride, pyrimidine-2,4-dicarbonyl dibromide, pyrimidine-2,5-dicarboxylic anhydride, pyrimidine-2,5-dicarbonyl difluoride, pyrimidine-2,5-dicarbonyl dichloride, pyrimidine-2,5-dicarbonyl dibromide, pyrimidine-4,6-dicarboxylic anhydride, pyrimidine-4,6-dicarbonyl difluoride, pyrimidine-4,6-dicarbonyl dichloride, pyrimidine-4,6-dicarbonyl dibromide, polyanhydrides of pyrimidine-2,4-dicarboxylic acid, polyanhydrides of pyrimidine-2,5-dicarboxylic acid, polyanhydrides of pyrimidine-4,6-dicarboxylic acid and also C₁-C₁₀-alkyl esters of pyrimidine-2,4-dicarboxylic acid, pyrimidine-2,5-dicarboxylic acid and pyrimidine-4,6-dicarboxylic acid and C₁-C₁₀-alkenyl esters of pyrimidine-2,4-dicarboxylic acid, pyrimidine-2,5-dicarboxylic acid and pyrimidine-4,6-dicarboxylic acid.

For the radical Ar¹, suitable unsubstituted or at least monosubstituted furandiyl groups are, for example, selected from furan-2,5-diyl. The furandiyl group is preferably unsubstituted. Appropriate aromatic dicarboxylic compounds (I) having a furandiyl group as radical Ar¹ include, for example, furan-2,5-dicarboxylic acid, furan-2,5-dicarboxylic anhydride, furan-2,5-dicarbonyl difluoride, furan-2,5-dicarbonyl dichloride, furan-2,5-dicarbonyl dibromide, polyanhydrides of furan-2,5-dicarboxylic acid, C₁-C₁₀-alkyl esters of furan-2,5-dicarboxylic acid and C₁-C₁₀-alkenyl esters of furan-2,5-dicarboxylic acid.

For the radical Ar¹, suitable unsubstituted or at least monosubstituted thiophenyldiyl groups are, for example, selected from thiophene-2,5-diyl. The thiophenediyl group is preferably unsubstituted. Appropriate aromatic dicarboxylic compounds (I) having a thiophenediyl group as radical Ar¹ include, for example, thiophene-2,5-dicarboxylic acid, thiophene-2,5-dicarboxylic anhydride, thiophene-2,5-dicarbonyl difluoride, thiophene-2,5-dicarbonyl dichloride, thiophene-2,5-dicarbonyl dibromide, polyanhydrides of thiophene-2,5-dicarboxylic acid, C₁-C₁₀-alkyl esters of thiophene-2,5-dicarboxylic acid and C₁-C₁₀-alkenyl esters of thiophene-2,5-dicarboxylic acid.

The radical Ar¹ is preferably selected from the group consisting of unsubstituted or at least monosubstituted 1,3-phenylene, 1,4-phenylene, naphthalene-1,4-diyl, naphthalene-2,6-diyl, anthracene-2,6-diyl, anthracene-9,10-diyl, biphenyl-4,4′-diyl, diphenylmethane-4,4′-diyl, diphenyl ether 4,4′-diyl, diphenyl thioether 4,4′-diyl, diphenyl sulfone 4,4′-diyl, benzophenone-4,4′-diyl, pyridine-2,5-diyl, pyrimidine-4,6-diyl, furan-2,5-diyl and thiophene-2,5-diyl. The radicals specified above are particularly preferably unsubstituted.

The present invention therefore also relates to a method, characterized in that Ar¹ is selected from the group consisting of unsubstituted or at least monosubstituted 1,3-phenylene, 1,4-phenylene, naphthalene-1,4-diyl, naphthalene-2,6-diyl, anthracene-2,6-diyl, anthracene-9,10-diyl, biphenyl-4,4′-diyl, diphenylmethane-4,4′-diyl, diphenyl ether 4,4′-diyl, diphenyl thioether 4,4′-diyl, diphenyl sulfone 4,4′-diyl, benzophenone-4,4′-diyl, pyridine-2,5-diyl, pyrimidine-4,6-diyl, furan-2,5-diyl and thiophene-2,5-diyl.

In the context of the present invention, the term “unsubstituted” signifies that the radical Ar¹ has no further substituents other than hydrogen (—H) besides the functional groups (—COX¹ and —COX²) depicted in the general formula (I).

In the context of the present invention, the expression “at least monosubstituted” signifies that the radical Ar¹, in addition to the functional groups depicted in the general formula (I), may have exactly one substituent or also two or more substituents in addition to the carboxyl groups depicted in the general formula (I).

Preferred C₁-C₁₀-alkyl groups comprise linear and branched, saturated alkyl groups having 1 to 10 carbon atoms. Particularly preferred C₁-C₁₀-alkyl groups here are C₁-C₆-alkyl groups such as methyl, ethyl, n-propyl, isopropyl, n-butyl, sec-butyl, 2- or 3-methylpentyl or longer-chain groups such as n-heptyl, n-octyl, n-nonyl or n-decyl and also branched isomers thereof.

Preferred C₁-C₁₀-alkenyl groups comprise linear and branched, at least monounsaturated alkyl groups having 1 to 10 carbon atoms. Particularly preferred C₁-C₁₀-alkenyl groups here are vinyl, allyl, isopropenyl, 1-butenyl, crotyl, 3-butenyl, 1,3-butadienyl or longer-chain groups such as pentenyl, pentadienyl, hexenyl, hexadienyl, hexatrienyl, heptenyl, heptadienyl, heptatrienyl, octenyl, octadienyl, octatrienyl, octatetraenyl, nonenyl, nonadienyl, nonatrienyl, nonatetradienyl, decenyl, decadienyl, decatrienyl, decatetraenyl or decapentaenyl and also branched isomers thereof.

m in the repeating unit of the general formula (Ia) is preferably a natural number from 1 to 50, particularly preferably from 1 to 30, very particularly preferably from 1 to 10 and especially from 1 to 5. Most preferably, m is 1.

Component (a) is preferably selected from the group consisting of isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid, C₁-C₁₀-alkenyl esters of isophthalic acid, terephthalic acid, terephthalic anhydride, terephthaloyl difluoride, terephthaloyl dichloride, terephthaloyl dibromide, polyanhydrides of terephthalic acid, C₁-C₁₀-alkyl esters of terephthalic acid, C₁-C₁₀-alkenyl esters of terephthalic acid, naphthalene-1,4-dicarboxylic acid, naphthalene-1,4-dicarboxylic anhydride, naphthalene-1,4-dicarbonyl difluoride, naphthalene-1,4-dicarbonyl dichloride, naphthalene-1,4-dicarbonyl dibromide, polyanhydrides of naphthalene-1,4-dicarboxylic acid, C₁-C₁₀-alkyl esters of naphthalene-1,4-dicarboxylic acid, C₁-C₁₀-alkenyl esters of naphthalene-1,4-dicarboxylic acid, naphthalene-2,6-dicarboxylic acid, naphthalene-2,6-dicarboxylic anhydride, naphthalene-2,6-dicarbonyl difluoride, naphthalene-2,6-dicarbonyl dichloride, naphthalene-2,6-dicarbonyl dibromide, polyanhydrides of naphthalene-2,6-dicarboxylic acid, C₁-C₁₀-alkyl esters of naphthalene-2,6-dicarboxylic acid, C₁-C₁₀-alkenyl esters of naphthalene-2,6-dicarboxylic acid, anthracene-2,6-dicarboxylic acid, anthracene-2,6-dicarboxylic anhydride, anthracene-2,6-dicarbonyl difluoride, anthracene-2,6-dicarbonyl dichloride, anthracene-2,6-dicarbonyl dibromide, polyanhydrides of anthracene-2,6-dicarboxylic acid, C₁-C₁₀-alkyl esters of anthracene-2,6-dicarboxylic acid, C₁-C₁₀-alkenyl esters of anthracene-2,6-dicarboxylic acid, anthracene-9,10-dicarboxylic acid, anthracene-9,10-dicarboxylic anhydride, anthracene-9,10-dicarbonyl difluoride, anthracene-9,10-dicarbonyl dichloride, anthracene-9,10-dicarbonyl dibromide, polyanhydrides of anthracene-9,10-dicarboxylic acid, C₁-C₁₀-alkyl esters of anthracene-9,10-dicarboxylic acid, C₁-C₁₀-alkenyl esters of anthracene-9,10-dicarboxylic acid, biphenyl-4,4′-dicarboxylic acid, biphenyl-4,4′-dicarboxylic anhydride, biphenyl-4,4′-dicarbonyl difluoride, biphenyl-4,4′-dicarbonyl dichloride, biphenyl-4,4′-dicarbonyl dibromide, polyanhydrides of biphenyl-4,4′-dicarboxylic acid, C₁-C₁₀-alkyl esters of biphenyl-4,4′-dicarboxylic acid, C₁-C₁₀-alkenyl esters of biphenyl-4,4′-dicarboxylic acid, diphenylmethane-4,4′-dicarboxylic acid, diphenylmethane-4,4′-dicarboxylic anhydride, diphenylmethane-4,4′-dicarbonyl difluoride, diphenylmethane-4,4′-dicarbonyl dichloride, diphenylmethane-4,4′-dicarbonyl dibromide, polyanhydrides of diphenylmethane-4,4′-dicarboxylic acid, C₁-C₁₀-alkyl esters of diphenylmethane-4,4′-dicarboxylic acid, C₁-C₁₀-alkenyl esters of diphenylmethane-4,4′-dicarboxylic acid, diphenyl ether 4,4′-dicarboxylic acid, diphenyl ether 4,4′-dicarboxylic anhydride, diphenyl ether 4,4′-dicarbonyl difluoride, diphenyl ether 4,4′-dicarbonyl dichloride, diphenyl ether 4,4′-dicarbonyl dibromide, polyanhydrides of diphenyl ether 4,4′-dicarboxylic acid, C₁-C₁₀-alkyl esters of diphenyl ether 4,4′-dicarboxylic acid, C₁-C₁₀-alkenyl esters of diphenyl ether 4,4′-dicarboxylic acid, diphenyl thioether 4,4′-dicarboxylic acid, diphenyl thioether 4,4′-dicarboxylic anhydride, diphenyl thioether 4,4′-dicarbonyl difluoride, diphenyl thioether 4,4′-dicarbonyl dichloride, diphenyl thioether 4,4′-dicarbonyl dibromide, polyanhydrides of diphenyl thioether 4,4′-dicarboxylic acid, C₁-C₁₀-alkyl esters of diphenyl thioether 4,4′-dicarboxylic acid, C₁-C₁₀-alkenyl esters of diphenyl thioether 4,4′-dicarboxylic acid, diphenyl sulfone 4,4′-dicarboxylic acid, diphenyl sulfone 4,4′-dicarboxylic anhydride, diphenyl sulfone 4,4′-dicarbonyl difluoride, diphenyl sulfone 4,4′-dicarbonyl dichloride, diphenyl sulfone 4,4′-dicarbonyl dibromide, polyanhydrides of diphenyl sulfone 4,4′-dicarboxylic acid, C₁-C₁₀-alkyl esters of diphenyl sulfone 4,4′-dicarboxylic acid, C₁-C₁₀-alkenyl esters of diphenyl sulfone 4,4′-dicarboxylic acid, benzophenone-4,4′-dicarboxylic acid, benzophenone-4,4′-dicarboxylic anhydride, benzophenone-4,4′-dicarbonyl difluoride, benzophenone-4,4′-dicarbonyl dichloride, benzophenone-4,4′-dicarbonyl dibromide, polyanhydrides of benzophenone-4,4′-dicarboxylic acid, C₁-C₁₀-alkyl esters of benzophenone-4,4′-dicarboxylic acid, C₁-C₁₀-alkenyl esters of benzophenone-4,4′-dicarboxylic acid, pyridine-2,5-dicarboxylic acid, pyridine-2,5-dicarboxylic anhydride, pyridine-2,5-dicarbonyl difluoride, pyridine-2,5-dicarbonyl dichloride, pyridine-2,5-dicarbonyl dibromide, polyanhydrides of pyridine-2,5-dicarboxylic acid, C₁-C₁₀-alkyl esters of pyridine-2,5-dicarboxylic acid, C₁-C₁₀-alkenyl esters of pyridine-2,5-dicarboxylic acid, pyrimidine-4,6-dicarboxylic acid, pyrimidine-4,6-dicarboxylic anhydride, pyrimidine-4,6-dicarbonyl difluoride, pyrimidine-4,6-dicarbonyl dichloride, pyrimidine-4,6-dicarbonyl dibromide, polyanhydrides of pyrimidine-4,6-dicarboxylic acid, C₁-C₁₀-alkyl esters of pyrimidine-4,6-dicarboxylic acid, C₁-C₁₀-alkenyl esters pyrimidine-4,6-dicarboxylic acid, furan-2,5-dicarboxylic acid, furan-2,5-dicarboxylic anhydride, furan-2,5-dicarbonyl difluoride, furan-2,5-dicarbonyl dichloride, furan-2,5-dicarbonyl dibromide, polyanhydrides of furan-2,5-dicarboxylic acid, C₁-C₁₀-alkyl esters of furan-2,5-dicarboxylic acid, C₁-C₁₀-alkenyl esters of furan-2,5-dicarboxylic acid, thiophene-2,5-dicarboxylic acid, thiophene-2,5-dicarboxylic anhydride, thiophene-2,5-dicarbonyl difluoride, thiophene-2,5-dicarbonyl dichloride, thiophene-2,5-dicarbonyl dibromide, polyanhydrides of thiophene-2,5-dicarboxylic acid, C₁-C₁₀-alkyl esters of thiophene-2,5-dicarboxylic acid and C₁-C₁₀-alkenyl esters of thiophene-2,5-dicarboxylic acid.

The present invention therefore also further relates to a method, characterized in that component (a) is selected from the group consisting of isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid, C₁-C₁₀-alkenyl esters of isophthalic acid, terephthalic acid, terephthalic anhydride, terephthaloyl difluoride, terephthaloyl dichloride, terephthaloyl dibromide, polyanhydrides of terephthalic acid, C₁-C₁₀-alkyl esters of terephthalic acid, C₁-C₁₀-alkenyl esters of terephthalic acid, naphthalene-1,4-dicarboxylic acid, naphthalene-1,4-dicarboxylic anhydride, naphthalene-1,4-dicarbonyl difluoride, naphthalene-1,4-dicarbonyl dichloride, naphthalene-1,4-dicarbonyl dibromide, polyanhydrides of naphthalene-1,4-dicarboxylic acid, C₁-C₁₀-alkyl esters of naphthalene-1,4-dicarboxylic acid, C₁-C₁₀-alkenyl esters of naphthalene-1,4-dicarboxylic acid, naphthalene-2,6-dicarboxylic acid, naphthalene-2,6-dicarboxylic anhydride, naphthalene-2,6-dicarbonyl difluoride, naphthalene-2,6-dicarbonyl dichloride, naphthalene-2,6-dicarbonyl dibromide, polyanhydrides of naphthalene-2,6-dicarboxylic acid, C₁-C₁₀-alkyl esters of naphthalene-2,6-dicarboxylic acid, C₁-C₁₀-alkenyl esters of naphthalene-2,6-dicarboxylic acid, anthracene-2,6-dicarboxylic acid, anthracene-2,6-dicarboxylic anhydride, anthracene-2,6-dicarbonyl difluoride, anthracene-2,6-dicarbonyl dichloride, anthracene-2,6-dicarbonyl dibromide, polyanhydrides of anthracene-2,6-dicarboxylic acid, C₁-C₁₀-alkyl esters of anthracene-2,6-dicarboxylic acid, C₁-C₁₀-alkenyl esters of anthracene-2,6-dicarboxylic acid, anthracene-9,10-dicarboxylic acid, anthracene-9,10-dicarboxylic anhydride, anthracene-9,10-dicarbonyl difluoride, anthracene-9,10-dicarbonyl dichloride, anthracene-9,10-dicarbonyl dibromide, polyanhydrides of anthracene-9,10-dicarboxylic acid, C₁-C₁₀-alkyl esters of anthracene-9,10-dicarboxylic acid, C₁-C₁₀-alkenyl esters of anthracene-9,10-dicarboxylic acid, biphenyl-4,4′-dicarboxylic acid, biphenyl-4,4′-dicarboxylic anhydride, biphenyl-4,4′-dicarbonyl difluoride, biphenyl-4,4′-dicarbonyl dichloride, biphenyl-4,4′-dicarbonyl dibromide, polyanhydrides of biphenyl-4,4′-dicarboxylic acid, C₁-C₁₀-alkyl esters of biphenyl-4,4′-dicarboxylic acid, C₁-C₁₀-alkenyl esters of biphenyl-4,4′-dicarboxylic acid, diphenylmethane-4,4′-dicarboxylic acid, diphenylmethane-4,4′-dicarboxylic anhydride, diphenylmethane-4,4′-dicarbonyl difluoride, diphenylmethane-4,4′-dicarbonyl dichloride, diphenylmethane-4,4′-dicarbonyl dibromide, polyanhydrides of diphenylmethane-4,4′-dicarboxylic acid, C₁-C₁₀-alkyl esters of diphenylmethane-4,4′-dicarboxylic acid, C₁-C₁₀-alkenyl esters of diphenylmethane-4,4′-dicarboxylic acid, diphenyl ether 4,4′-dicarboxylic acid, diphenyl ether 4,4′-dicarboxylic anhydride, diphenyl ether 4,4′-dicarbonyl difluoride, diphenyl ether 4,4′-dicarbonyl dichloride, diphenyl ether 4,4′-dicarbonyl dibromide, polyanhydrides of diphenyl ether 4,4′-dicarboxylic acid, C₁-C₁₀-alkyl esters of diphenyl ether 4,4′-dicarboxylic acid, C₁-C₁₀-alkenyl esters of diphenyl ether 4,4′-dicarboxylic acid, diphenyl thioether 4,4′-dicarboxylic acid, diphenyl thioether 4,4′-dicarboxylic anhydride, diphenyl thioether 4,4′-dicarbonyl difluoride, diphenyl thioether 4,4′-dicarbonyl dichloride, diphenyl thioether 4,4′-dicarbonyl dibromide, polyanhydrides of diphenyl thioether 4,4′-dicarboxylic acid, C₁-C₁₀-alkyl esters of diphenyl thioether 4,4′-dicarboxylic acid, C₁-C₁₀-alkenyl esters of diphenyl thioether 4,4′-dicarboxylic acid, diphenyl sulfone 4,4′-dicarboxylic acid, diphenyl sulfone 4,4′-dicarboxylic anhydride, diphenyl sulfone 4,4′-dicarbonyl difluoride, diphenyl sulfone 4,4′-dicarbonyl dichloride, diphenyl sulfone 4,4′-dicarbonyl dibromide, polyanhydrides of diphenyl sulfone 4,4′-dicarboxylic acid, C₁-C₁₀-alkyl esters of diphenyl sulfone 4,4′-dicarboxylic acid, C₁-C₁₀-alkenyl esters of diphenyl sulfone 4,4′-dicarboxylic acid, benzophenone-4,4′-dicarboxylic acid, benzophenone-4,4′-dicarboxylic anhydride, benzophenone-4,4′-dicarbonyl difluoride, benzophenone-4,4′-dicarbonyl dichloride, benzophenone-4,4′-dicarbonyl dibromide, polyanhydrides of benzophenone-4,4′-dicarboxylic acid, C₁-C₁₀-alkyl esters of benzophenone-4,4′-dicarboxylic acid, C₁-C₁₀-alkenyl esters of benzophenone-4,4′-dicarboxylic acid, pyridine-2,5-dicarboxylic acid, pyridine-2,5-dicarboxylic anhydride, pyridine-2,5-dicarbonyl difluoride, pyridine-2,5-dicarbonyl dichloride, pyridine-2,5-dicarbonyl dibromide, polyanhydrides of pyridine-2,5-dicarboxylic acid, C₁-C₁₀-alkyl esters of pyridine-2,5-dicarboxylic acid, C₁-C₁₀-alkenyl esters of pyridine-2,5-dicarboxylic acid, pyrimidine-4,6-dicarboxylic acid, pyrimidine-4,6-dicarboxylic anhydride, pyrimidine-4,6-dicarbonyl difluoride, pyrimidine-4,6-dicarbonyl dichloride, pyrimidine-4,6-dicarbonyl dibromide, polyanhydrides of pyrimidine-4,6-dicarboxylic acid, C₁-C₁₀-alkyl esters of pyrimidine-4,6-dicarboxylic acid, C₁-C₁₀-alkenyl esters pyrimidine-4,6-dicarboxylic acid, furan-2,5-dicarboxylic acid, furan-2,5-dicarboxylic anhydride, furan-2,5-dicarbonyl difluoride, furan-2,5-dicarbonyl dichloride, furan-2,5-dicarbonyl dibromide, polyanhydrides of furan-2,5-dicarboxylic acid, C₁-C₁₀-alkyl esters of furan-2,5-dicarboxylic acid, C₁-C₁₀-alkenyl esters of furan-2,5-dicarboxylic acid, thiophene-2,5-dicarboxylic acid, thiophene-2,5-dicarboxylic anhydride, thiophene-2,5-dicarbonyl difluoride, thiophene-2,5-dicarbonyl dichloride, thiophene-2,5-dicarbonyl dibromide, polyanhydrides of thiophene-2,5-dicarboxylic acid, C₁-C₁₀-alkyl esters of thiophene-2,5-dicarboxylic acid and C₁-C₁₀-alkenyl esters of thiophene-2,5-dicarboxylic acid.

Component (a) is particularly preferably selected from the group consisting of terephthalic acid, terephthalic anhydride, terephthaloyl difluoride, terephthaloyl dichloride, terephthaloyl dibromide and C₁-C₁₀-alkyl esters of terephthalic acid.

The reaction mixture (R_{G}) preferably comprises at least 5% by weight component (a), based on the total weight of the reaction mixture (R_{G}). The reaction mixture (R_{G}) particularly preferably comprises at least 8% by weight and very particularly preferably at least 10% by weight component (a), based on the total weight of the reaction mixture (R_{G}).

Furthermore, the reaction mixture (R_{G}) preferably comprises at most 25% by weight component (a), based on the total weight of the reaction mixture (R_{G}). The reaction mixture (R_{G}) particularly preferably comprises at most 18% by weight and very particularly preferably at most 15% by weight component (a), based on the total weight of the reaction mixture (R_{G}). The total weight of all components in the reaction mixture (R_{G}) generally adds up to 100% by weight.

The reaction mixture (R_{G}) preferably comprises 5 to 25% by weight component (a), based on the total weight of the reaction mixture (R_{G}). The reaction mixture (R_{G}) particularly preferably comprises 8 to 18% by weight and very particularly preferably 10 to 15% by weight component (a), based on the total weight of the reaction mixture (R_{G}).

In a preferred embodiment, component (a) comprises at least 80% by weight, particularly preferably at least 90% by weight and very particularly preferably at least 98% by weight of at least one aromatic dicarboxylic compound of the general formula (I) selected from the group consisting of terephthalic acid, terephthalic anhydride, terephthaloyl difluoride, terephthaloyl dichloride, terephthaloyl dibromide, C₁-C₁₀-alkyl esters of terephthalic acid and C₁-C₁₀-alkenyl esters of terephthalic acid, based on the total weight of component (a) in the reaction mixture (R_{G}). The weight data specified here with respect to component (a) refer in this case to the total weight used of terephthalic acid, terephthalic anhydride, terephthaloyl difluoride, terephthaloyl dichloride, terephthaloyl dibromide, C₁-C₁₀-alkyl esters of terephthalic acid and C₁-C₁₀-alkenyl esters of terephthalic acid.

In a particularly preferred embodiment, component (a) consists essentially of at least one aromatic dicarboxylic compound of the general formula (I) selected from the group consisting of terephthalic acid, terephthalic anhydride, terephthaloyl difluoride, terephthaloyl dichloride, terephthaloyl dibromide, C₁-C₁₀-alkyl esters of terephthalic acid and C₁-C₁₀-alkenyl esters of terephthalic acid.

In the context of the present invention, the expression “consists essentially of” is understood to mean that component (a) comprises at least 99% by weight, preferably at least 99.5% by weight and particularly preferably at least 99.9% by weight of at least one aromatic dicarboxylic compound of the general formula (I) selected from the group consisting of terephthalic acid, terephthalic anhydride, terephthaloyl difluoride, terephthaloyl dichloride, terephthaloyl dibromide, C₁-C₁₀-alkyl esters of terephthalic acid and C₁-C₁₀-alkenyl esters of terephthalic acid, based on the total weight of component (a) in the reaction mixture (R_{G}).

In a further particularly preferred embodiment, component (a) consists essentially of at least one aromatic dicarboxylic compound of the general formula (I) selected from terephthalic anhydride, terephthaloyl dichloride and C₁-C₁₀-alkenyl esters of terephthalic acid.

In a particularly preferred embodiment, component (a) is terephthaloyl dichloride.

### Component (b)

The reaction mixture (R_{G}) comprises at least one aromatic diamino compound of the general formula (IIa), (IIb), (IIc) and/or (IId) as component (b).

The expressions “component (b)”, “at least one aromatic diamino compound of the general formula (IIa), (IIb), (IIc) and/or (IId)” and “at least one aromatic diamino compound (IIa-d)” are used synonymously hereinafter.

The expression “at least one aromatic diamino compound of the general formula (IIa), (IIb), (IIc) and/or (IId)” refers here to exactly one aromatic diamino compound of the general formula (IIa), (IIb), (IIc) and/or (IId) and also to mixtures of two or more different aromatic diamino compounds of the general formula (IIa), (IIb), (IIc) and/or (IId). Suitable aromatic diamino compounds of the general formula (IIa), (IIb), (IIc) and/or (IId) are known in principle to those skilled in the art.

The at least one aromatic diamino compound (IIa-d) used in the method according to the invention comprises two amino groups. The designation “amino group” is understood in the context of the present invention to mean —NH₂. It is clear to those skilled in the art that amino groups can also be in protonated form as amino-hydrogen salts (—NH₃⁺ Q⁻), wherein Q⁻ is an anion equivalent selected from the group consisting of fluoride (F⁻), chloride (Cl⁻), bromide (Br⁻), iodide(I⁻), hydrogensulfate (HSO₄⁻), sulfate (SO₄²⁻), methanesulfonate (H₃C—SO₃⁻), p-toluenesulfonate (p-H₃C—C₆H₄—SO₃—) and nitrate (NO₃⁻).

In the context of the present application, a person skilled in the art understands that “an anion equivalent” is an anion having a single negative charge or a charge equivalent of an anion having two or more negative charges.

The at least one aromatic diamino compound used in the method according to the invention has the general formula (IIa), (IIb), (IIc) and/or (IId):

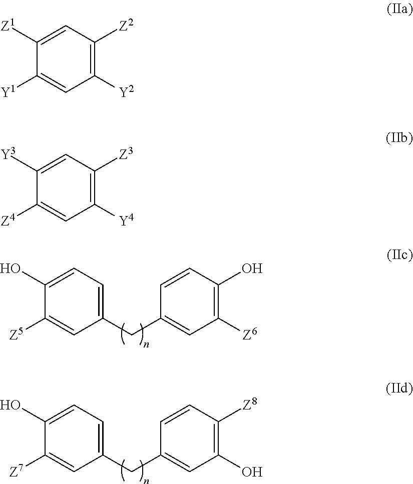

in which
n is 0 or 1
Y¹, Y², Y³, Y⁴ are each independently —H, —OR⁴ or —SR⁴,
   wherein R⁴ is selected from the group consisting of —H, —C₁-C₁₀-alkyl, trimethylsilyl, triethylsilyl, tert-butyldimethylsilyl, acetyl and tert-butyloxycarbonyl, and
   wherein at most one of the radicals Y¹ and Y² is —H, and
   wherein at most one of the radicals Y³ and Y⁴ is —H;
Z¹, Z², Z³, Z⁴, Z⁵, Z⁶, Z⁷, Z⁸ are each independently —NH₂ or —NH₃⁺Q⁻,
   wherein Q⁻ is an anion equivalent selected from the group consisting of F⁻, Cl⁻, Br⁻, I⁻, HSO₄⁻, SO₄²⁻, H₃C—SO₃⁻, p-H₃C—C₆H₄—SO₃⁻ and NO₃⁻.

Preferred C₁-C₁₀-alkyl groups comprise linear and branched, saturated alkyl groups having 1 to 10 carbon atoms. Particularly preferred C₁-C₁₀-alkyl groups here are C₁-C₆-alkyl groups such as methyl, ethyl, n-propyl, isopropyl, n-butyl, sec-butyl, 2- or 3-methylpentyl or longer-chain groups such as n-heptyl, n-octyl, n-nonyl or n-decyl and also branched isomers thereof.

In the at least one aromatic diamino compound of the general formula (IIa), (IIb), (IIc) and/or (IId), Y¹, Y², Y³ and Y⁴ are each independently preferably hydroxyl groups or thiol groups.

The designation “hydroxyl groups” is understood in the context of the present invention to mean —OH. In analogy thereto, “thiol groups” are understood to mean —SH in the context of the present invention.

In a particularly preferred embodiment, Y¹, Y², Y³ and Y⁴ in the at least one aromatic diamino compound of the general formula (IIa) and/or (IIb) are hydroxyl groups.

Z¹, Z², Z³, Z⁴, Z⁵, Z⁶, Z⁷ and Z⁸ are each independently amino groups (—NH₂) or amino-hydrogen salts (—NH₃⁺ Q⁻). Z¹, Z², Z³, Z⁴, Z⁵, Z⁶, Z⁷ and Z⁸ in the at least one aromatic diamino compound of the general formula (IIa), (IIb), (IIc) and/or (IId) are preferably amino-hydrogen salts.

Component (b) is preferably selected from the group consisting of 4,6-diamino-1,3-dihydroxybenzene, 4,6-diamino-1,3-dithiobenzene, 4,6-diamino-3-hydroxy-1-thiobenzene, 2,5-diamino-1,4-dihydroxybenzene, 2,5-diamino-1,4-dithiobenzene, 2,5-diamino-4-hydroxy-1-thiobenzene, 4,6-diamino-1,3-dihydroxybenzene dihydrochloride, 4,6-diamino-1,3-dithiobenzene dihydrochloride, 4,6-diamino-3-hydroxy-1-thiobenzene dihydrochloride, 2,5-diamino-1,4-dihydroxybenzene dihydrochloride, 2,5-diamino-1,4-dithiobenzene dihydrochloride, 2,5-diamino-4-hydroxy-1-thiobenzene dihydrochloride, 3,3′-diamino-4,4′-dihydroxybiphenyl, 3,3′-diamino-4,4′-dihydroxybiphenyl dihydrochloride, 4,4′-diamino-3,3′-dihydroxybiphenyl, 4,4′-diamino-3,3′-dihydroxybiphenyl dihydrochloride, 3,3′-diamino-4,4′-dihydroxydiphenylmethane, 3,3′-diamino-4,4′-dihydroxydiphenylmethane dihydrochloride, 4,4′-diamino-3,3′-dihydroxydiphenylmethane and 4,4′-diamino-3,3′-dihydroxydiphenylmethane dihydrochloride.

The present application therefore also relates to a method, characterized in that component (b) is preferably selected from the group consisting of 4,6-diamino-1,3-dihydroxybenzene, 4,6-diamino-1,3-dithiobenzene, 4,6-diamino-3-hydroxy-1-thiobenzene, 2,5-diamino-1,4-dihydroxybenzene, 2,5-diamino-1,4-dithiobenzene, 2,5-diamino-4-hydroxy-1-thiobenzene, 4,6-diamino-1,3-dihydroxybenzene dihydrochloride, 4,6-diamino-1,3-dithiobenzene dihydrochloride, 4,6-diamino-3-hydroxy-1-thiobenzene dihydrochloride, 2,5-diamino-1,4-dihydroxybenzene dihydrochloride, 2,5-diamino-1,4-dithiobenzene dihydrochloride, 2,5-diamino-4-hydroxy-1-thiobenzene dihydrochloride, 3,3′-diamino-4,4′-dihydroxybiphenyl, 3,3′-diamino-4,4′-dihydroxybiphenyl dihydrochloride, 4,4′-diamino-3,3′-dihydroxybiphenyl, 4,4′-diamino-3,3′-dihydroxybiphenyl dihydrochloride, 3,3′-diamino-4,4′-dihydroxydiphenylmethane, 3,3′-diamino-4,4′-dihydroxydiphenylmethane dihydrochloride, 4,4′-diamino-3,3′-dihydroxydiphenylmethane and 4,4′-diamino-3,3′-dihydroxydiphenylmethane dihydrochloride.

Component (b) is particularly preferably selected from the group consisting of 4,6-diamino-1,3-dihydroxybenzene and 4,6-diamino-1,3-dihydroxybenzene dihydrochloride.

The reaction mixture (R_{G}) preferably comprises at least 5% by weight component (b), based on the total weight of the reaction mixture (R_{G}). The reaction mixture (R_{G}) particularly preferably comprises at least 8% by weight and very particularly preferably at least 10% by weight component (b), based on the total weight of the reaction mixture (R_{G}).

Furthermore, the reaction mixture (R_{G}) preferably comprises at most 25% by weight component (b), based on the total weight of the reaction mixture (R_{G}). The reaction mixture (R_{G}) particularly preferably comprises at most 18% by weight and very particularly preferably at most 15% by weight component (b), based on the total weight of the reaction mixture (R_{G}). The total weight of all components in the reaction mixture (R_{G}) generally adds up to 100% by weight.

The reaction mixture (R_{G}) preferably comprises 5 to 30% by weight component (b), based on the total weight of the reaction mixture (R_{G}). The reaction mixture (R_{G}) particularly preferably comprises 8 to 18% by weight and very particularly preferably 10 to 15% by weight component (b), based on the total weight of the reaction mixture (R_{G}).

In a preferred embodiment, component (b) comprises at least 80% by weight, particularly preferably at least 90% by weight and very particularly preferably at least 98% by weight of at least one aromatic diamino compound (IIa-d) selected from the group consisting of 4,6-diamino-1,3-dihydroxybenzene and 4,6-diamino-1,3-dihydroxybenzene dihydrochloride, based on the total weight of component (b) in the reaction mixture (R_{G}). The weight data specified here with respect to component (b) refer in this case to the total weight of 4,6-diamino-1,3-dihydroxybenzene and 4,6-diamino-1,3-dihydroxybenzene dihydrochloride used.

In a further particularly preferred embodiment, component (b) consists essentially of at least one aromatic diamino compound (IIa-d) selected from the group consisting of 4,6-diamino-1,3-dihydroxybenzene and 4,6-diamino-1,3-dihydroxybenzene dihydrochloride. In the context of the present invention, the expression “consists essentially of” is understood to mean that component (b) comprises at least 99% by weight, preferably at least 99.5% by weight and particularly preferably at least 99.9% by weight of at least one aromatic diamino compound (IIa-d) selected from the group consisting of 4,6-diamino-1,3-dihydroxybenzene and 4,6-diamino-1,3-dihydroxybenzene dihydrochloride, based on the total weight of component (b) in the reaction mixture (R_{G}).

In a particularly preferred embodiment, component (b) consists of at least one aromatic diamino compound (IIa-d) selected from the group consisting of 4,6-diamino-1,3-dihydroxybenzene and 4,6-diamino-1,3-dihydroxybenzene dihydrochloride.

In these embodiments, component (b) is particularly preferably 4,6-diamino-1,3-dihydroxybenzene dihydrochloride.

The end groups of the polybenzazole polymer (P) are dependent on the reaction conditions and the molar ratio between component (a) and component (b) and are preferably an alkyl or aryl radical, which is obtained by means of a capping reagent.

Suitable capping reagents are known in principle to those skilled in the art and include monocarboxylic acids, monocarbonyl chlorides, nitriles, ortho-aminophenols, ortho-aminothiols or ortho-diamines.

Preferred capping reagents include, for example, benzoic acid, 4-phenylbenzoic acid, cyclohexanecarboxylic acid, picolinic acid, naphthoic acid, acetic acid, propionic acid, benzoyl chloride, 4-phenylbenzoyl chloride, cyclohexancarbonyl chloride, picolinoyl chloride, naphthoyl chloride, acetyl chloride, propionyl chloride, benzonitrile, 4-phenylbenzonitrile, cyanocyclohexane, acetonitrile, propionitrile, ortho-aminophenol, ortho-aminonaphthol, ortho-aminothiophenol, ortho-aminothionaphthol, ortho-diaminophenol, or ortho-diaminonaphthol.

### Component (c)

The reaction mixture (R_{G}) comprises at least one ionic liquid (IL) as component (c).

The expressions “component (c)” and “at least one ionic liquid (IL)” are used synonymously hereinafter.

The expression “at least one ionic liquid (IL)” refers here to exactly one ionic liquid (IL) and also to mixtures of two or more different ionic liquids (IL). Suitable ionic liquids (IL) are known in principle to those skilled in the art.

Ionic liquids in the context of the present invention are understood to mean compounds having at least one cationic center and at least one anionic center, in particular which have at least one cation and at least one anion, in which at least one of the ions, in particular the cation, is organic.

Ionic liquids, according to the definition of Wasserscheid and Keim in: Angewandte Chemie, 112, 3926-3945 (2000), are salts having non-molecular ionic character that melt at relatively low temperatures. They are liquid, with a relatively low viscosity, at relatively low temperatures. They have very good solvent capabilities for a large number of organic, inorganic and polymeric substances. They are also generally noncombustible, noncorrosive and have no measurable vapor pressure.

Ionic liquids are compounds which are formed by positive and negative ions, but have no overall charge. Both the positive ions and the negative ions are predominantly monovalent, but multivalent anions and/or cations, for example ions having one to five, preferably one to four, more preferably one to three and most preferably one or two electric charges per ion, are also possible. The charges can be situated on various localized or delocalized regions within a molecule, i.e., in betaine-like fashion, or else be distributed like a separate anion and cation. Preference is given to ionic liquids constructed of at least one cation and at least one anion.

Known fields of use for ionic liquids are described by way of example in DE 10202838, in WO 02/074718 or in “Proceeding of Solar Forum, 2001, April 21 to 25, Washington, D.C.”.

The invention is not restricted to specific ionic liquids; it is possible to use all suitable ionic liquids known to those skilled in the art.

The at least one ionic liquid (IL) preferably has a melting point as low as possible. The melting point of the at least one ionic liquid (IL) is preferably below 150° C., particularly preferably below 100° C. and very particularly preferably below 80° C.

The at least one ionic liquid (IL) preferably has the general formula (III):

[C]ₙ⁺[A]ⁿ⁻ (III)

in which
n=1, 2, 3 or 4;
the cation [C]ₙ⁺ is at least one cation selected from the group consisting of unsubstituted or at least monosubstituted imidazolium cations, imidazolinium cations, imidazolidinium cations, quaternary ammonium cations, quaternary phosphonium cations, pyrazolium cations, pyrazolinium cations, pyridinium cations, pyridazinium cations, pyrimidinium cations, pyrazinium cations, pyrrolidinium cations, guanidinium cations, thiazolium cations, oxazolium cations, triazolium cations, the 1,8-diazabicyclo[5.4.0]undec-7-enium cation, the 1,8-diazabicyclo[4.3.0]non-5-enium cation and oligomers or polymers comprising these cations,
   wherein the substituents are selected from the group consisting of linear or branched —C₁-C₁₈-alkyl, —C₅-C₁₂-cycloalkyl and —C₆-C₁₄-aryl;
the anion [A]ⁿ⁻ is selected from the group consisting of halide-containing anions, cyanide, thiocyanate, cyanate, isocyanate, nitrite, nitrate, unsubstituted or at least monosubstituted sulfates, sulfites, sulfonates, carboxylates, borates, boronates, carbonates, carbonate esters, amides, carboximidates, sulfonyl imidates, bis(sulfonyl) imidates, alkoxides and aryl oxides,
   wherein the substituents are selected from the group consisting of linear or branched —C₁-C₁₈-alkyl, —C₅-C₁₂-cycloalkyl and —C₆-C₁₄-aryl.

The present application therefore also further relates to a method, characterized in that the at least one ionic liquid (IL) has the general formula (III):

[C]ₙ⁺[A]ⁿ⁻ (III)

in which
n=1, 2, 3 or 4;
the cation [C]ₙ⁺ is at least one cation selected from the group consisting of unsubstituted or at least monosubstituted imidazolium cations, imidazolinium cations, imidazolidinium cations, quaternary ammonium cations, quaternary phosphonium cations, pyrazolium cations, pyrazolinium cations, pyridinium cations, pyridazinium cations, pyrimidinium cations, pyrazinium cations, pyrrolidinium cations, guanidinium cations, thiazolium cations, oxazolium cations, triazolium cations, the 1,8-diazabicyclo[5.4.0]undec-7-enium cation, the 1,8-diazabicyclo[4.3.0]non-5-enium cation and oligomers or polymers comprising these cations,
   wherein the substituents are selected from the group consisting of linear or branched —C₁-C₁₈-alkyl, —C₅-C₁₂-cycloalkyl and —C₆-C₁₄-aryl;
the anion [A]ⁿ⁻ is selected from the group consisting of halide-containing anions, cyanide, thiocyanate, cyanate, isocyanate, nitrite, nitrate, unsubstituted or at least monosubstituted sulfates, sulfites, sulfonates, carboxylates, borates, boronates, carbonates, carbonate esters, amides, carboximidates, sulfonyl imidates, bis(sulfonyl) imidates, alkoxides and aryl oxides, wherein the substituents are selected from the group consisting of linear or branched —C₁-C₁₈-alkyl, —C₅-C₁₂-cycloalkyl and —C₆-C₁₄-aryl.

The expression “at least one cation” refers here not only to precisely one cation but also to mixed species of two or more cations such as

[C¹]⁺[C²]⁺2 [A]⁻, [C¹]⁺[C²]⁺[A]²⁻, [C¹]⁺[C²]⁺[C³]⁺[A]³⁻ or [C¹]⁺[C²]⁺[C³]⁺[C⁴]⁺[A]⁴⁻
where C¹, C², C³ and C⁴ are each independently selected from the groups specified for [C]ₙ.

In addition, mixed species with metal cations can also be used, such as

[C¹]⁺[C²]⁺[C³]⁺[M¹]⁺[A]⁴⁻, [C¹]⁺[C²]⁺[M¹]⁺[M²]⁺[A]⁴⁻,
[C¹]⁺[M¹]⁺[M²]⁺[M³]⁺[A]⁴⁻, [C¹]⁺[C²]⁺[M¹]⁺[A]³⁻, [C¹]⁺[M¹]⁺[M²]⁺[A]³⁻,
[C¹]⁺[M¹]⁺[A]²⁻, [C¹]⁺[M¹]⁺2 [A]⁻, [C¹]⁺[C²]⁺[M⁴]²⁺[A]⁴⁻, [C¹]⁺[M¹]⁺[M⁴]²⁺[A]⁴⁻,
[C¹]⁺[M⁵]³⁺[A]⁴⁻[C¹]⁺[M⁴]²⁺[A]³⁻
where M¹, M², M³ are monovalent metal cations, M⁴ is divalent metal cations and M⁵ is trivalent metal cations.

The cation [C]ₙ⁺ is preferably at least one unsubstituted or at least monosubstituted cation selected from the group consisting of
imidazolium cations of the general formula (IV)

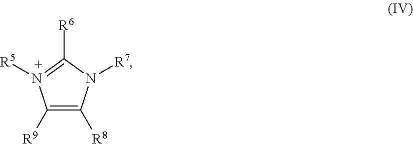

and also all isomeric imidazolinium cations and imidazolidinium cations analogous to the formula above,
quaternary ammonium cations of the general formula (V)

[NR⁵R⁶R⁷R⁸]⁺ (V),
quaternary phosphonium cations of the general formula (VI)

[PR⁵R⁶R⁷R⁸]⁺ (VI),
-H-pyrazolium cations of the general formula (VII)

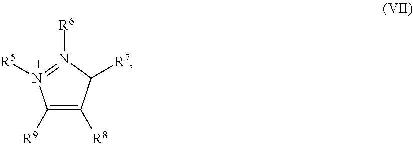

and also 3H-pyrazolium cations, 4H-pyrazolium cations, 1-pyrazolinium cations, 2-pyrazolinium cations and 3-pyrazolinium cations,
pyridinium cations of the general formula (VIII)

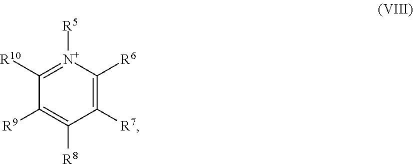

and also pyridazinium, pyrimidinium and pyrazinium ions,
pyrrolidinium cations of the general formula (IX)

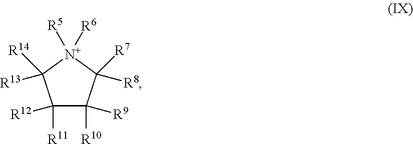

guanidinium cations of the general formula (X)

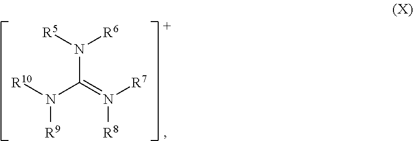

five- to six-membered heterocyclic cations comprising at least one phosphorus or nitrogen atom and also optionally an oxygen or a sulfur atom such as, for example, thiazolium, oxazolium, 1,2,4-triazolium or 1,2,3-triazolium cations, particularly preferably those compounds comprising at least one five- to six-membered heterocycle comprising one, two or three nitrogen atoms and one oxygen or one sulfur atom, very particularly preferably those having one or two nitrogen atoms,
the 1,8-diazabicyclo[5.4.0]undec-7-enium cation and the 1,8-diazabicyclo[4.3.0]non-5-enium cation of the general formula (XI)

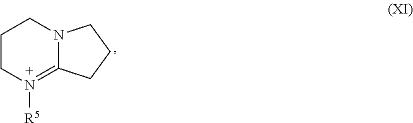

and also oligomers and polymers comprising these cations,
where R⁵, R⁶, R⁷, R⁸, R⁹ R¹⁰, R¹¹, R¹², R¹³ and R¹⁴ are each independently selected from the group consisting of —H, —C₁-C₁₈-alkyl, —C₅-C₁₂-cycloalkyl and —C₆-C₁₄-aryl.

It is clear to a person skilled in the art that the general formulae (IV), (VII), (VIII) and (X) are in each case a possible mesomeric resonance structure of the relevant cation and the positive charge is delocalized over several mesomeric resonance structures.

For the radicals R⁵, R⁶, R⁷, R⁸, R⁹, R¹⁰, R¹¹, R¹², R¹³ and R¹⁴ in the general formulae (IV) to (XI), preferred C₁-C₁₈-alkyl groups include linear and branched saturated alkyl groups having 1 to 18 carbon atoms, which are optionally interrupted by one or more oxygen and/or sulfur atoms and/or one or more unsubstituted or at least monosubstituted imino groups, in which the C₁-C₈-alkyl groups may optionally be substituted by functional groups and/or halogen groups.

The number of oxygen and/or sulfur atoms and/or imino groups is not restricted. Generally, they are not more than 5 in the radical, preferably not more than 4 and very particularly preferably not more than 3. There is moreover generally at least one carbon atom, preferably at least two carbon atoms, between two heteroatoms.

Unsubstituted or at least monosubstituted imino groups may be, for example, imino, methylimino, isopropylimino, n-butylimino or tert-butylimino.

Preferred functional groups include for example carboxy, carboxamide, hydroxyl, di(C₁-C₄-alkyl)amino, C₁-C₄-alkyloxycarbonyl, cyano or C₁-C₄-alkyloxy.

Preferred C₁-C₁₈-alkyl groups include, for example, C₁-C₄-alkyl groups such as methyl, ethyl, n-propyl, isopropyl, n-butyl, sec-butyl, tert-butyl or longer-chain alkyl groups such as n-pentyl, n-heptyl, n-octyl, n-nonyl, n-decyl, n-dodecyl, n-tetradecyl, n-hexadecyl or n-octadecyl and branched isomers thereof.

Further preferred C₁-C₁₈-alkyl group substituted by functional groups and/or halogen groups include, for example, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, 2-butoxyethyl, diethoxymethyl, diethoxyethyl, 2-isopropoxyethyl, 2-butoxypropyl, chloromethyl, 2-chloroethyl, trichloromethyl, trifluoromethyl, 1,1-dimethyl-2-chloroethyl, 2-methoxyisopropyl, 2-ethoxyethyl, 2,2,2-trifluoroethyl, 2-hydroxyethyl, 2-hydroxypropyl, 3-hydroxypropyl, 4-hydroxybutyl, 6-hydroxyhexyl or 2-hydroxy-2,2-dimethylethyl.

Further preferred C₁-C₁₈-alkyl groups, which have been interrupted by one or more oxygen atoms and/or sulfur atoms and/or one or more unsubstituted or at least monosubstituted imino groups include, for example, butylthiomethyl, 2-dodecylthioethyl, 2-phenylthioethyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

For the radicals R⁵, R⁶, R⁷, R⁸, R⁹, R¹⁰, R¹¹, R¹², R¹³ and R¹⁴ in the general formulae (IV) to (XI), preferred C₅-C₁₂-cycloalkyl groups include unsubstituted or at least monosubstituted saturated cycloalkyl groups having 5 to 12 carbon atoms, which are optionally interrupted by one or more oxygen and/or sulfur atoms and/or one or more unsubstituted or at least monosubstituted imino groups, in which the C₅-C₁₂-cycloalkyl groups may optionally be substituted by functional groups and/or halogen groups.

Preferred C₅-C₁₂-cycloalkyl groups include, for example, cyclopentyl, cyclohexyl, cycloheptyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, 1,3-dioxolan-2-yl, 2-methyl-1,3-dioxolan-2-yl, 4-methyl-1,3-dioxolan-2-yl or norbornyl.

For the radicals R⁵, R⁶, R⁷, R⁸, R⁹, R¹⁰, R¹¹, R¹², R¹³ and R¹⁴ in the general formulae (IV) to (XI), preferred C₆-C₁₄-aryl groups include unsubstituted or at least monosubstituted aryl groups having 6 to 14 carbon atoms, in which the C₆-C₁₄-aryl groups may optionally be substituted by functional groups and/or halogen groups.

Preferred C₆-C₁₄-aryl groups include, for example, phenyl, tolyl, xylyl, benzyl, α-naphthyl, 4-diphenylyl, chlorophenyl, dichlorophenyl, trichlorophenyl, difluorophenyl, p-chlorobenzyl, 2,4-dichlorobenzyl, methylphenyl, dimethylphenyl, trimethylphenyl, ethylphenyl, diethylphenyl, isopropylphenyl, tert-butylphenyl, 1-phenylethyl, 2-phenylethyl, α,α-dimethylbenzyl, benzhydryl, p-tolylmethyl, 1-(p-butylphenyl)ethyl, dodecylphenyl, methoxyphenyl, dimethoxyphenyl, ethoxyphenyl, hexyloxyphenyl, p-methoxybenzyl, m-ethoxybenzyl, 2-phenoxyethyl, 2-phenoxypropyl, 3-phenoxypropyl, 4-phenoxybutyl, 6-phenoxyhexyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl or ethoxymethylphenyl.

Preferably, R⁵, R⁶, R⁷, R⁸, R⁹, R¹⁰, R¹¹, R¹², R¹³ and R¹⁴ are each independently selected from the group consisting of —H, methyl, ethyl, n-propyl, isopropyl, n-butyl, tert-butyl, n-pentyl, n-hexyl, 2-hydroxyethyl, 2-cyanoethyl, 2-(methoxycarbonyl)ethyl, 2-(ethoxycarbonyl)ethyl, 2-(n-butoxycarbonyl)ethyl, benzyl, acetyl, dimethylamino, diethylamino and chlorine.

The at least one ionic liquid (IL) particularly preferably comprises at least one imidazolium cation of the general formula (IV) as cation [C]ₙ⁺:

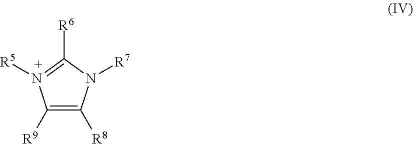

in which
R⁵, R⁶, R⁷, R⁸, R⁹ are each independently selected from the group consisting of —H, linear or branched —C₁-C₁₈-alkyl, —C₅-C₁₂-cycloalkyl and —C₆-C₁₄-aryl.

The present application therefore also further relates to a method, characterized in that the at least one ionic liquid (IL) comprises at least one imidazolium cation of the general formula (IV) as cation [C]ₙ⁺:

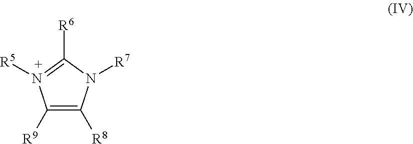

in which
R⁵, R⁶, R⁷, R⁸, R⁹ are each independently selected from the group consisting of —H, linear or branched —C₁-C₁l-alkyl, —C₅-C₁₂-cycloalkyl and —C₆-C₁₄-aryl.

The cation [C]ₙ⁺ is preferably at least one cation selected from the group consisting of 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methylimidazolium, 1-ethyl-3-methylimidazolium, 1-ethyl-2,3-dimethylimidazolium, 2-ethyl-3,4-dimethylimidazolium, 1-propylimidazolium, 1-propyl-2-methylimidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethylimidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium and 1-benzyl-3-methylimidazolium.

The present application therefore also further relates to a method, characterized in that the cation [C]ₙ⁺ is at least one cation selected from the group consisting of 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methylimidazolium, 1-ethyl-3-methylimidazolium, 1-ethyl-2,3-dimethylimidazolium, 2-ethyl-3,4-dimethylimidazolium, 1-propylimidazolium, 1-propyl-2-methylimidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethylimidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium and 1-benzyl-3-methylimidazolium.

The cation [C]ₙ⁺ is particularly preferably a cation selected from the group consisting of 1-methylimidazolium, 1,2-dimethylimidazolium, 1,2,3-trimethylimidazolium, 1-methyl-2-ethylimidazolium, 1-ethylimidazolium, 1-ethyl-2-methylimidazolium, 1-ethyl-2,3-dimethylimidazolium, 1-ethyl-3-methylimidazolium, 1,3-diethylimidazolium, 1-propylimidazolium, 1-propyl-3-methylimidazolium, 1-butylimidazolium, 1-butyl-2-methylimidazolium, 1-butyl-3-methylimidazolium, 1-butyl-2,3-dimethylimidazolium, 1,3-dibutylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-3-methylimidazolium, 1-decyl-3-methylimidazolium, 1-dodecyl-3-methylimidazolium and 1-benzyl-3-methylimidazolium.

The cation [C]ₙ⁺ is very particularly preferably at least one cation selected from the group consisting of 1-methylimidazolium, 1,2-dimethylimidazolium, 1,2,3-trimethylimidazolium, 1-ethylimidazolium, 1-ethyl-2-methylimidazolium, 1-ethyl-2,3-dimethylimidazolium, 1-ethyl-3-methylimidazolium, 1,3-diethylimidazolium, 1-butylimidazolium, 1-butyl-2-methylimidazolium, 1-butyl-3-methylimidazolium and 1-butyl-2,3-dimethylimidazolium, 1,3-dibutylimidazolium.

As anions, it is in principle possible to use all anions.

The anion [A]ⁿ⁻ is preferably selected from the group consisting of
the group of halogen-containing anions such as:
   F⁻, Cl⁻, Br⁻, I⁻, BF₄⁻, BCl₄⁻, PF₆⁻, AsF₆⁻, SbF₆⁻, AlCl₄⁻, Al₂Cl₇⁻, AlBr₄⁻, Al₂Br₇—, ZnC₃⁻, SnCl₃⁻, FeCl₄⁻,
the group consisting of cyanide, thiocyanate, cyanate and isocyanate:
   CN⁻, SCN⁻, OCN⁻, NCO⁻,
the group consisting of nitrite and nitrate:
   NO₂⁻, NO₃⁻
the group of the sulfates, sulfites or sulfonates of the general formulae:
   SO₄²⁻, HSO₄⁻, SO₃²⁻, HSO₃⁻, R^{a}OSO₃⁻, R^{a}SO₃⁻,
the group of the carboxylates of the general formula:
   R^{a}COO⁻,
the group of the borates of the general formulae:
   BO₃³⁻, HBO₃²⁻, H₂BO₃⁻, R^{a}R^{b}BO₃⁻, R^{a}HBO₃⁻, R^{a}BO₃²⁻,
the group of the boronates of the general formulae:
   R^{a}BO₂²⁻, R^{a}R^{b}BO⁻,
the group of the carbonates or carbonic esters of the general formulae:
   HCO₃⁻, CO₃²⁻, R^{a}CO₃⁻,
the group of the amides of the general formulae:
   H₂N⁻, R²NH⁻, R^{a}R^{b}N⁻,
the group of the carboximidates, bis(sulfonyl)imidates or sulfonylimidates of the general formulae:

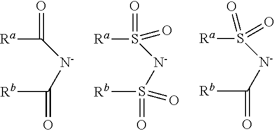

the group of the alkoxides or aryl oxides of the general formula:

RaO⁻,

where R^{a} and R^{b} are each independently selected from the group consisting of —H, —C₁-C₁₈-alkyl, —C₅-C₁₂-cycloalkyl and —C₆-C₁₄-aryl.

For the radicals R^{a} and R^{b}, preferred C₁-C₁₈-alkyl groups include linear and branched saturated alkyl groups having 1 to 18 carbon atoms, which are optionally interrupted by one or more oxygen and/or sulfur atoms and/or one or more unsubstituted or at least monosubstituted imino groups, in which the C₁-C₁₈-alkyl groups may optionally be substituted by functional groups and/or halogen groups.

The number of oxygen and/or sulfur atoms and/or imino groups is not restricted. Generally, they are not more than 5 in the radical, preferably not more than 4 and very particularly preferably not more than 3. There is moreover generally at least one carbon atom, preferably at least two carbon atoms, between two heteroatoms.

Unsubstituted or at least monosubstituted imino groups may be, for example, imino, methylimino, isopropylimino, n-butylimino or tert-butylimino.

Preferred functional groups include for example carboxy, carboxamide, hydroxyl, di(C₁-C₄-alkyl)amino, C₁-C₄-alkyloxycarbonyl, cyano or C₁-C₄-alkyloxy.

Preferred C₁-C₁₈-alkyl groups include, for example, C₁-C₄-alkyl groups such as methyl, ethyl, n-propyl, isopropyl, n-butyl, sec-butyl, tert-butyl or longer-chain alkyl groups such as n-pentyl, n-heptyl, n-octyl, n-nonyl, n-decyl, n-dodecyl, n-tetradecyl, n-hexadecyl or n-octadecyl and branched isomers thereof.

Further preferred C₁-C₁₈-alkyl group substituted by functional groups and/or halogen groups include, for example, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, 2-butoxyethyl, diethoxymethyl, diethoxyethyl, 2-isopropoxyethyl, 2-butoxypropyl, chloromethyl, 2-chloroethyl, trichloromethyl, trifluoromethyl, 1,1-dimethyl-2-chloroethyl, 2-methoxyisopropyl, 2-ethoxyethyl, 2,2,2-trifluoroethyl, 2-hydroxyethyl, 2-hydroxypropyl, 3-hydroxypropyl, 4-hydroxybutyl, 6-hydroxyhexyl or 2-hydroxy-2,2-dimethylethyl.

Further preferred C₁-C₁₈-alkyl groups, which have been interrupted by one or more oxygen atoms and/or sulfur atoms and/or one or more unsubstituted or at least monosubstituted imino groups include, for example, butylthiomethyl, 2-dodecylthioethyl, 2-phenylthioethyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

For the radicals R^{a} and R^{b}, preferred C₅-C₁₂-cycloalkyl groups include unsubstituted or at least monosubstituted saturated cycloalkyl groups having 5 to 12 carbon atoms, which are optionally interrupted by one or more oxygen and/or sulfur atoms and/or one or more unsubstituted or at least monosubstituted imino groups, in which the C₅-C₁₂-cycloalkyl groups may optionally be substituted by functional groups and/or halogen groups.

Preferred C₅-C₁₂-cycloalkyl groups include, for example, cyclopentyl, cyclohexyl, cycloheptyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, 1,3-dioxolan-2-yl, 2-methyl-1,3-dioxolan-2-yl, 4-methyl-1,3-dioxolan-2-yl or norbornyl.

For the radicals R^{a} and R^{b}, preferred C₆-C₁₄-aryl groups include unsubstituted or at least monosubstituted aryl groups having 6 to 14 carbon atoms, in which the C₆-C₁₄-aryl groups may optionally be substituted by functional groups and/or halogen groups.

Preferred C₆-C₁₄-aryl groups include, for example, phenyl, tolyl, xylyl, benzyl, α-naphthyl, 4-diphenylyl, chlorophenyl, dichlorophenyl, trichlorophenyl, difluorophenyl, p-chlorobenzyl, 2,4-dichlorobenzyl, methylphenyl, dimethylphenyl, trimethylphenyl, ethylphenyl, diethylphenyl, isopropylphenyl, tert-butylphenyl, 1-phenylethyl, 2-phenylethyl, α,α-dimethylbenzyl, benzhydryl, p-tolylmethyl, 1-(p-butylphenyl)ethyl, dodecylphenyl, methoxyphenyl, dimethoxyphenyl, ethoxyphenyl, hexyloxyphenyl, p-methoxybenzyl, m-ethoxybenzyl, 2-phenoxyethyl, 2-phenoxypropyl, 3-phenoxypropyl, 4-phenoxybutyl, 6-phenoxyhexyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl or ethoxymethylphenyl.

R^{a} and R^{b} are preferably each independently selected from the group consisting of —H, methyl, ethyl, n-propyl, isopropyl, n-butyl, tert-butyl, n-pentyl, n-hexyl, 2-hydroxyethyl, 2-cyanoethyl, 2-(methoxycarbonyl)ethyl, 2-(ethoxycarbonyl)ethyl, 2-(n-butoxycarbonyl)ethyl, benzyl, acetyl, dimethylamino, diethylamino and chlorine.

The anion [A]ⁿ⁻ is preferably selected from the group consisting of fluoride, chloride, bromide, iodide, tetrafluoroborate, hexafluorophosphate, tetrachloroaluminate, heptachlorodialuminate, tetrabromoaluminate, heptabromodialuminate, trichlorozincate, thiocyanate, nitrite, nitrate, sulfate, hydrogensulfate, methylsulfate, ethylsulfate, sulfite, hydrogensulfite, methanesulfonate, trifluoromethanesulfonate, ethanesulfonate, tosylate, decylbenzenesulfonate, didecylbenzenesulfonate, dodecylbenzenesulfonate, didodecylbenzenesulfonate, bis(trifluoromethanesulfonyl)methane, acetate, trifluoroacetate, borate, tetracyanoborate, bis(oxalato)borate, bis(malonato)borate, bis(phtalato)borate, bis(salicylato)borate, tetrakis(hydrogensulfato)borate, tetrakis(methylsulfonato)borate, carbonate, methylcarbonate, hydrogencarbonate, dicyanamide, bis(trifluoromethyl)imidate and bis(trifluoromethanesulfonyl)imidate.

The anion [A]ⁿ⁻ is particularly preferably selected from the group consisting of chloride, tetrachloroaluminate, heptachlorodialuminate, trichlorozincate, sulfate, hydrogensulfate, methylsulfate, ethylsulfate, methanesulfonate, trifluoromethanesulfonate, ethanesulfonate, tosylate, decylbenzenesulfonate, didecylbenzenesulfonate, dodecylbenzenesulfonate, didodecylbenzenesulfonate, acetate, carbonate, methylcarbonate and hydrogencarbonate.

The anion [A]ⁿ⁻ is very particularly preferably selected from the group consisting of chloride, tetrachloroaluminate, sulfate, hydrogensulfate, methylsulfate, ethylsulfate, methanesulfonate, trifluoromethanesulfonate, tosylate, acetate, methylcarbonate and hydrogencarbonate.

The at least one ionic liquid (IL) is preferably selected from the group consisting of 1-methylimidazolium chloride, 1,2-dimethylimidazolium chloride, 1,3-dimethylimidazolium chloride, 1,2,3-trimethylimidazolium chloride, 1-ethylimidazolium chloride, 1-ethyl-2-methylimidazolium chloride, 1-ethyl-3-methylimidazolium chloride, 1-ethyl-2,3-dimethylimidazolium chloride, 1,3-diethylimidazolium chloride, 1-butylimidazolium chloride, 1-butyl-2-methylimidazolium chloride, 1-butyl-3-methylimidazolium chloride, 1-butyl-2,3-dimethylimidazolium chloride, 1,3-dibutylimidazolium chloride, 1-methylimidazolium tetrachloroaluminate, 1,2-dimethylimidazolium tetrachloroaluminate, 1,3-dimethylimidazolium tetrachloroaluminate, 1,2,3-trimethylimidazolium tetrachloroaluminate, 1-ethyl tetrachloroaluminate, 1-ethyl-2-methyl tetrachloroaluminate, 1-ethyl-3-methylimidazolium tetrachloroaluminate, 1-ethyl-2,3-dimethylimidazolium tetrachloroaluminate, 1,3-diethylimidazolium tetrachloroaluminate, 1-butylimidazolium tetrachloroaluminate, 1-butyl-2-methylimidazolium tetrachloroaluminate, 1-butyl-3-methylimidazolium tetrachloroaluminate, 1-butyl-2,3-dimethylimidazolium tetrachloroaluminate, 1,3-dibutylimidazolium tetrachloroaluminate, 1-methylimidazolium sulfate, 1,2-dimethylimidazolium sulfate, 1,3-dimethylimidazolium sulfate, 1,2,3-trimethylimidazolium sulfate, 1-ethylimidazolium sulfate, 1-ethyl-2-methylimidazolium sulfate, 1-ethyl-3-methylimidazolium sulfate, 1-ethyl-2,3-dimethylimidazolium sulfate, 1,3-diethylimidazolium sulfate, 1-butylimidazolium sulfate, 1-butyl-2-methylimidazolium sulfate, 1-butyl-3-methylimidazolium sulfate, 1-butyl-2,3-dimethylimidazolium sulfate, 1,3-dibutylimidazolium sulfate, 1-methylimidazolium hydrogensulfate, 1,2-dimethylimidazolium hydrogensulfate, 1,3-dimethylimidazolium hydrogensulfate, 1,2,3-trimethylimidazolium hydrogensulfate, 1-ethylimidazolium hydrogensulfate, 1-ethyl-2-methylimidazolium hydrogensulfate, 1-ethyl-3-methylimidazolium hydrogensulfate, 1-ethyl-2,3-dimethylimidazolium hydrogensulfate, 1,3-diethylimidazolium hydrogensulfate, 1-butylimidazolium hydrogensulfate, 1-butyl-2-methylimidazolium hydrogensulfate, 1-butyl-3-methylimidazolium hydrogensulfate, 1-butyl-2,3-dimethylimidazolium hydrogensulfate, 1,3-dibutylimidazolium hydrogensulfate, 1-methylimidazolium methylsulfate, 1,2-dimethylimidazolium methylsulfate, 1,3-dimethylimidazolium methylsulfate, 1,2,3-trimethylimidazolium methylsulfate, 1-ethylimidazolium methylsulfate, 1-ethyl-2-methylimidazolium methylsulfate, 1-ethyl-3-methylimidazolium methylsulfate, 1-ethyl-2,3-dimethylimidazolium methylsulfate, 1,3-diethylimidazolium methylsulfate, 1-butylimidazolium methylsulfate, 1-butyl-2-methylimidazolium methylsulfate, 1-butyl-3-methylimidazolium methylsulfate, 1-butyl-2,3-dimethylimidazolium methylsulfate, 1,3-dibutylimidazolium methylsulfate, 1-methylimidazolium ethylsulfate, 1,2-dimethylimidazolium ethylsulfate, 1,3-dimethylimidazolium ethylsulfate, 1,2,3-trimethylimidazolium ethylsulfate, 1-ethylimidazolium ethylsulfate, 1-ethyl-2-methylimidazolium ethylsulfate, 1-ethyl-3-methylimidazolium ethylsulfate, 1-ethyl-2,3-dimethylimidazolium ethylsulfate, 1,3-diethylimidazolium ethylsulfate, 1-butylimidazolium ethylsulfate, 1-butyl-2-methylimidazolium ethylsulfate, 1-butyl-3-methylimidazolium ethylsulfate, 1-butyl-2,3-dimethylimidazolium ethylsulfate, 1,3-dibutylimidazolium ethylsulfate, 1-methylimidazolium methanesulfonate, 1,2-dimethylimidazolium methanesulfonate, 1,3-dimethylimidazolium methanesulfonate, 1,2,3-trimethylimidazolium methanesulfonate, 1-ethylimidazolium methanesulfonate, 1-ethyl-2-methylimidazolium methanesulfonate, 1-ethyl-3-methylimidazolium methanesulfonate, 1-ethyl-2,3-dimethylimidazolium methanesulfonate, 1,3-diethylimidazolium methanesulfonate, 1-butylimidazolium methanesulfonate, 1-butyl-2-methylimidazolium methanesulfonate, 1-butyl-3-methylimidazolium methanesulfonate, 1-butyl-2,3-dimethylimidazolium methanesulfonate, 1,3-dibutylimidazolium methanesulfonate, 1-methylimidazolium trifluoromethanesulfonate, 1,2-dimethylimidazolium trifluoromethanesulfonate, 1,3-dimethylimidazolium trifluoromethanesulfonate, 1,3-dimethylimidazolium trifluoromethanesulfonate, 1,2,3-trimethylimidazolium trifluoromethanesulfonate, 1-ethylimidazolium trifluoromethanesulfonate, 1-ethyl-2-methylimidazolium trifluoromethanesulfonate, 1-ethyl-3-methylimidazolium trifluoromethanesulfonate, 1-ethyl-2,3-dimethylimidazolium trifluoromethanesulfonate, 1,3-diethylimidazolium trifluoromethanesulfonate, 1-butylimidazolium trifluoromethanesulfonate, 1-butyl-2-methylimidazolium trifluoromethanesulfonate, 1-butyl-3-methylimidazolium trifluoromethanesulfonate, 1-butyl-2,3-dimethylimidazolium trifluoromethanesulfonate, 1,3-dibutylimidazolium trifluoromethanesulfonate, 1-methylimidazolium tosylate, 1,2-dimethylimidazolium tosylate, 1,3-dimethylimidazolium tosylate, 1,2,3-trimethylimidazolium tosylate, 1-ethylimidazolium tosylate, 1-ethyl-2-methylimidazolium tosylate, 1-ethyl-3-methylimidazolium tosylate, 1-ethyl-2,3-dimethylimidazolium tosylate, 1,3-diethylimidazolium tosylate, 1-butylimidazolium tosylate, 1-butyl-2-methylimidazolium tosylate, 1-butyl-3-methylimidazolium tosylate, 1-butyl-2,3-dimethylimidazolium tosylate, 1,3-dibutylimidazolium tosylate, 1-methylimidazolium acetate, 1,2-dimethylimidazolium acetate, 1,3-dimethylimidazolium acetate, 1,2,3-trimethylimidazolium acetate, 1-ethylimidazolium acetate, 1-ethyl-2-m ethylimidazolium acetate, 1-ethyl-3-methylimidazolium acetate, 1-ethyl-2,3-dimethylimidazolium acetate, 1,3-diethylimidazolium acetate, 1-butylimidazolium acetate, 1-butyl-2-methylimidazolium acetate, 1-butyl-3-methylimidazolium acetate, 1-butyl-2,3-dimethylimidazolium acetate, 1,3-dibutylimidazolium acetate, 1-methylimidazolium methylcarbonate, 1,2-dimethylimidazolium methylcarbonate, 1,3-dimethylimidazolium methylcarbonate, 1,2,3-trimethylimidazolium methylcarbonate, 1-ethylimidazolium methylcarbonate, 1-ethyl-2-methylimidazolium methylcarbonate, 1-ethyl-3-methylimidazolium methylcarbonate, 1-ethyl-2,3-dimethylimidazolium methylcarbonate, 1,3-diethylimidazolium methylcarbonate, 1-butylimidazolium methylcarbonate, 1-butyl-2-methylimidazolium carbonate, 1-butyl-3-methylimidazolium methylcarbonate, 1-butyl-2,3-dimethylimidazolium methylcarbonate, 1,3-dibutylimidazolium methylcarbonate, 1-methylimidazolium hydrogencarbonate, 1,2-dimethylimidazolium hydrogencarbonate, 1,3-dimethylimidazolium hydrogencarbonate, 1,2,3-trimethylimidazolium hydrogencarbonate, 1-ethylimidazolium hydrogencarbonate, 1-ethyl-2-methylimidazolium hydrogencarbonate, 1-ethyl-3-methylimidazolium hydrogencarbonate, 1-ethyl-2,3-dimethylimidazolium hydrogencarbonate, 1,3-diethylimidazolium hydrogencarbonate, 1-butylimidazolium hydrogencarbonate, 1-butyl-2-methylimidazolium hydrogencarbonate, 1-butyl-3-methylimidazolium hydrogencarbonate, 1-butyl-2,3-dimethylimidazolium hydrogencarbonate and 1,3-dibutylimidazolium hydrogencarbonate.

The at least one ionic liquid (IL) is particularly preferably selected from the group consisting of 1-methylimidazolium chloride, 1,3-dimethylimidazolium chloride, 1-ethylimidazolium chloride, 1-ethyl-3-methylimidazolium chloride, 1-ethyl-2,3-dimethylimidazolium chloride, 1,3-diethylimidazolium chloride, 1-butylimidazolium chloride, 1-butyl-3-methylimidazolium chloride, 1-butyl-2,3-dimethylimidazolium chloride, 1,3-dibutylimidazolium chloride, 1-methylimidazolium tetrachloroaluminate, 1,3-dimethylimidazolium tetrachloroaluminate, 1-ethylimidazolium tetrachloroaluminate, 1-ethyl-3-methylimidazolium tetrachloroaluminate, 1-ethyl-2,3-dimethylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1-butyl-2,3-dimethylimidazolium tetrachloroaluminate, 1,3-dibutylimidazolium tetrachloroaluminate, 1-methylimidazolium hydrogensulfate, 1,3-dimethylimidazolium hydrogensulfate, 1-ethylimidazolium hydrogensulfate, 1-ethyl-3-methylimidazolium hydrogensulfate, 1-ethyl-2,3-dimethylimidazolium hydrogensulfate, 1,3-diethylimidazolium hydrogensulfate, 1-butylimidazolium hydrogensulfate, 1-butyl-3-methylimidazolium hydrogensulfate, 1-butyl-2,3-dimethylimidazolium hydrogensulfate, 1,3-dibutylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1-ethyl-2,3-dimethylimidazolium methanesulfonate, 1,3-diethylimidazolium methanesulfonate, 1-butylimidazolium methanesulfonate, 1-butyl-3-methylimidazolium methanesulfonate, 1-butyl-2,3-dimethylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1-ethyl-2,3-dimethylimidazolium acetate, 1,3-diethylimidazolium acetate, 1-butylimidazolium acetate, 1-butyl-3-methylimidazolium acetate, 1-butyl-2,3-dimethylimidazolium acetate, 1,3-dibutylimidazolium acetate, 1,3-dimethylimidazolium methylcarbonate, 1-ethyl-3-methylimidazolium methylcarbonate, 1-ethyl-2,3-dimethylimidazolium acetate, 1-butyl-3-methylimidazolium methylcarbonate and 1-butyl-2,3-dimethylimidazolium methylcarbonate.

The at least one ionic liquid (IL) is very particularly preferably selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate.

The present invention therefore also further relates to a method, characterized in that the at least one ionic liquid (IL) is selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate.

The reaction mixture (R_{G}) preferably comprises at least 50% by weight component (c), based on the total weight of the reaction mixture (R_{G}). The reaction mixture (R_{G}) particularly preferably comprises at least 64% by weight and very particularly preferably at least 70% by weight component (c), based on the total weight of the reaction mixture (R_{G}).

Furthermore, the reaction mixture (R_{G}) preferably comprises at most 90% by weight component (c), based on the total weight of the reaction mixture (R_{G}). The reaction mixture (R_{G}) particularly preferably comprises at most 84% by weight and very particularly preferably at most 80% by weight component (c), based on the total weight of the reaction mixture (R_{G}). The total weight of all components in the reaction mixture (R_{G}) generally adds up to 100% by weight.

The reaction mixture (R_{G}) preferably comprises 50 to 90% by weight component (c), based on the total weight of the reaction mixture (R_{G}). The reaction mixture (R_{G}) particularly preferably comprises 64 to 84% by weight and very particularly preferably 70 to 80% by weight component (c), based on the total weight of the reaction mixture (R_{G}).

In one embodiment, component (c) comprises at least 80% by weight, preferably at least 90% by weight and particularly preferably at least 98% by weight of at least one ionic liquid (IL) selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate, based on the total weight of component (c) in the reaction mixture (R_{G}).

In a further preferred embodiment, component (c) essentially consists of at least one ionic liquid (IL) selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate.

In the context of the present invention, the expression “essentially consists of” is understood to mean that component (c) comprises at least 99% by weight, preferably at least 99.5% by weight and particularly preferably at least 99.9% by weight of at least one ionic liquid (IL) selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate, based on the total weight of component (c) in the reaction mixture (R_{G}).

In a further particularly preferred embodiment, component (c) consists of at least one ionic liquid (IL) selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate.

In these embodiments, particular preference is given to 1-methylimidazolium chloride, 1-methylimidazolium tetrachloroaluminate, 1-methylimidazolium methanesulfonate, 1-ethylimidazolium chloride, 1-ethyl-3-methylimidazolium chloride, 1-ethyl-3-methylimidazolium tetrachloroaluminate, 1-ethyl-3-methylimidazolium methanesulfonate, 1-butylimidazolium chloride, 1-butyl-3-methylimidazolium chloride, 1-butyl-3-methylimidazolium tetrachloroaluminate and 1-butyl-3-methylimidazolium methanesulfonate.

The at least one ionic liquid (IL) used in the method according to the invention is also suitable in principle as solvent in the production of aromatic polyamides (aramids). Relevant aramids include, for example, poly(p-phenylene terephthalamide) (PPTA), which is also obtainable under the trade names Kevlar® or Twaron®, and poly(m-phenylene isophthalamide) (PMPI), which is obtainable under the trade name Nomex®.

### Polybenzazole Polymer (P)

The polybenzazole polymer (P) is produced by the method according to the invention.

The present invention therefore also further relates to the polybenzazole polymer (P) which is produced by the method according to the invention.

The polybenzazole polymer (P) preferably has repeating units of the general formula (XIIa), (XIIb), (XIIc), (XIId), (XIIe) and/or (XIIf):

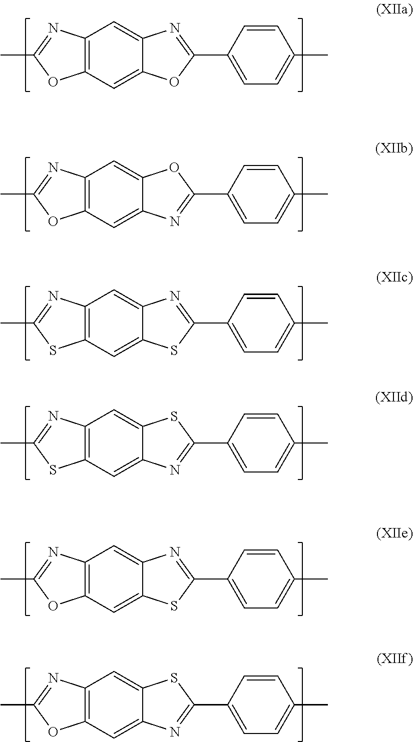

In a preferred embodiment, the polybenzazole polymer (P) comprises at least 40% by weight, preferably at least 60% by weight and particularly preferably at least 80% by weight of repeating units selected from the group consisting of repeating units of the general formulae (XIIa), (XIIb), (XIIc), (XIId), (XIIe) and (XIIf), based on the total weight of the polybenzazole polymer (P).

In a particularly preferred embodiment, the polybenzazole polymer (P) comprises at least 40% by weight, preferably at least 60% by weight and particularly preferably at least 80% by weight of repeating units selected from the group consisting of repeating units of the general formulae (XIIa) and (XIIb).

The weight data specified here with respect to the repeating units of the general formulae (XIIa), (XIIb), (XIIc), (XIId), (XIIe) und (XIIf) refer here to the total weight of repeating units of the general formula (XIIa), (XIIb), (XIIc), (XIId), (XIIe) and (XIIf).

In a further particularly preferred embodiment, the polybenzazole polymer (P) essentially consists of repeating units selected from the group consisting of repeating units of the general formulae (XIIa) and (XIIb). In the context of the present invention, the expression “essentially consists of” is understood to mean that the polybenzazole polymer (P) comprises at least 95% by weight, preferably at least 97% by weight and particularly preferably at least 99% by weight of repeating units selected from the group consisting of repeating units of the general formulae (XIIa) and (XIIb), based on the total weight of the polybenzazole polymer (P).

In a further particularly preferred embodiment, the polybenzazole polymer (P) consists of repeating units selected from the group consisting of repeating units of the general formulae (XIIa) and (XIIb).

The polybenzazole polymer (P) is particularly preferably poly(p-phenylene-2,6-benzobisoxazole).

The polybenzazole polymer (P) obtained by the method according to the invention generally has a viscosity number from 5 to 40 dl/g, preferably from 10 to 35 dl/g and particularly preferably from 15 to 30 dl/g. The viscosity number is determined in accordance with DIN EN ISO 1628-1 at 25° C. in methanesulfonic acid.

The weight-average molecular weight (Mw) of the polybenzazole polymer (P) obtained by the method according to the invention is generally in the range from 20 000 to 200 000 g/mol, preferably in the range from 40 000 to 180 000 g/mol and particularly preferably in the range from 60 000 to 120 000 g/mol. The weight-average molecular weight was by measuring the static light scattering of a solution of the polybenzazole polymer (P) in a solution of lithium sulfate (50 mmol/L) in methanesulfonic acid/methanesulfonic anhydride (1% by weight).

The content of sulfur-containing or phosphorus-containing acids in the polybenzazole polymer (P) is preferably less than 1000 ppm, preferably less than 100 ppm and particularly preferably the polybenzazole polymer (P) comprises absolutely no sulfur-containing or phosphorus-containing acids.

The present invention therefore also further provides the polybenzazole polymer (P), characterized in that the content of sulfur-containing or phosphorus-containing acids in the polybenzazole polymer (P) is less than 1000 ppm.

Relevant sulfur-containing or phosphorus-containing acids are generally known to those skilled in the art and include in particular phosphoric acid, polyphosphoric acid, sulfuric acid, methanesulfonic acid, trifluoromethanesulfonic acid and chlorosulfonic acid.

The polybenzazole polymer (P) produced by the method according to the invention can be used in many industrial sectors, for example as fiber material, in thermally stable membranes for gas separation, in proton-conducting membranes, in electro-optical devices or light-emitting diodes, especially as fiber material.

The present invention thus further provides the use of the polybenzazole polymer (P) as fiber material.

1: A method for producing a polybenzazole polymer (P), comprising reacting a reaction mixture (RG) comprising:
(a) at least one aromatic dicarboxylic compound of formula (I), 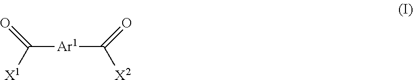
in which
Ar¹ is selected from the group consisting of unsubstituted or at least monosubstituted phenylene, naphthalenediyl, anthracenediyl, biphenyldiyl, diphenylmethanediyl, diphenyl ether diyl, diphenyl thio ether diyl, diphenyl sulfone diyl, benzophenonediyl, pyridinediyl, pyrimidinediyl, furandiyl and thiophenediyl,
wherein the substituents are selected from the group consisting of —F, —Cl, —Br, —OR¹ and —C₁-C₁₀-alkyl,
wherein R¹ is —H or —C₁-C₁₀-alkyl;
X¹, X² are each independently selected from the group consisting of —OR², —F, —Cl and —Br,
wherein R² is —H, —C₁-C₁₀-alkyl, —C₁-C₁₀-alkenyl or a repeating unit of formula (Ia): 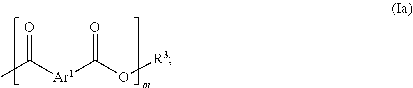
in which
m is a natural number from 1 to 50, and
R³ is —H, —C₁-C₁₀-alkyl or —C₁-C₁₀-alkenyl;
(b) at least one aromatic diamino compound of formula (IIa), (IIb), (IIc) and/or (IId): 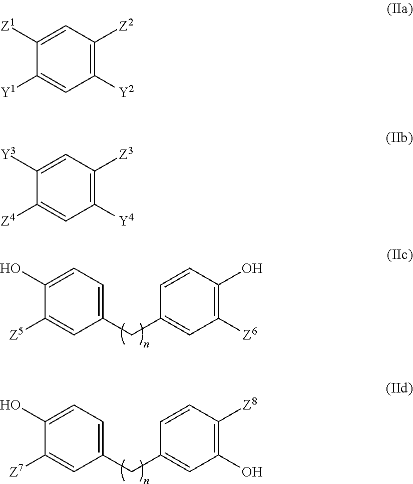
in which
n is 0 or 1,
Y¹, Y², Y³, Y⁴ are each independently —H, —OR⁴ or —SR⁴,
wherein R⁴ is selected from the group consisting of —H, —C₁-C₁₀-alkyl, trimethylsilyl, tert-butyldimethylsilyl, acetyl and tert-butyloxycarbonyl, and
wherein at most one of the radicals Y¹ and Y² is —H, and
wherein at most one of the radicals Y³ and Y⁴ is —H;
Z¹, Z², Z³, Z⁴, Z⁵, Z⁶, Z⁷, Z⁸ are each independently —NH₂ or —NH₃⁺ Q⁻,
wherein Q⁻ is an anion equivalent selected from the group consisting of F⁻, Cl⁻, Br⁻, I⁻, HSO₄⁻, SO₄²⁻, H₃C—SO₃⁻, p-H₃C—C₆H₄—SO₃⁻ and NO₃⁻;
and
(c) at least one ionic liquid (IL);
to obtain a product mixture (P) comprising the polybenzazole polymer (P) and the at least one ionic liquid (IL).

2: The method according to claim 1, wherein Ar¹ is selected from the group consisting of unsubstituted or at least monosubstituted 1,3-phenylene, 1,4-phenylene, naphthalene-1,4-diyl, naphthalene-2,6-diyl, anthracene-2,6-diyl, anthracene-9,10-diyl, biphenyl-4,4′-diyl, diphenylmethane-4,4′-diyl, diphenyl ether 4,4′-diyl, diphenyl thioether 4,4′-diyl, diphenyl sulfone 4,4′-diyl, benzophenone-4,4′-diyl, pyridine-2,5-diyl, pyrimidine-4,6-diyl, furan-2,5-diyl and thiophene-2,5-diyl.

3: The method according to claim 1, wherein component (a) is selected from the group consisting of isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid, C₁-C₁₀-alkenyl esters of isophthalic acid, terephthalic acid, terephthalic anhydride, terephthaloyl difluoride, terephthaloyl dichloride, terephthaloyl dibromide, polyanhydrides of terephthalic acid, C₁-C₁₀-alkyl esters of terephthalic acid, C₁-C₁₀-alkenyl esters of terephthalic acid, naphthalene-1,4-dicarboxylic acid, naphthalene-1,4-dicarboxylic anhydride, naphthalene-1,4-dicarbonyl difluoride, naphthalene-1,4-dicarbonyl dichloride, naphthalene-1,4-dicarbonyl dibromide, polyanhydrides of naphthalene-1,4-dicarboxylic acid, C₁-C₁₀-alkyl esters of naphthalene-1,4-dicarboxylic acid, C₁-C₁₀-alkenyl esters of naphthalene-1,4-dicarboxylic acid, naphthalene-2,6-dicarboxylic acid, naphthalene-2,6-dicarboxylic anhydride, naphthalene-2,6-dicarbonyl difluoride, naphthalene-2,6-dicarbonyl dichloride, naphthalene-2,6-dicarbonyl dibromide, polyanhydrides of naphthalene-2,6-dicarboxylic acid, C₁-C₁₀-alkyl esters of naphthalene-2,6-dicarboxylic acid, C₁-C₁₀-alkenyl esters of naphthalene-2,6-dicarboxylic acid, anthracene-2,6-dicarboxylic acid, anthracene-2,6-dicarboxylic anhydride, anthracene-2,6-dicarbonyl difluoride, anthracene-2,6-dicarbonyl dichloride, anthracene-2,6-dicarbonyl dibromide, polyanhydrides of anthracene-2,6-dicarboxylic acid, C₁-C₁₀-alkyl esters of anthracene-2,6-dicarboxylic acid, C₁-C₁₀-alkenyl esters of anthracene-2,6-dicarboxylic acid, anthracene-9,10-dicarboxylic acid, anthracene-9,10-dicarboxylic anhydride, anthracene-9,10-dicarbonyl difluoride, anthracene-9,10-dicarbonyl dichloride, anthracene-9,10-dicarbonyl dibromide, polyanhydrides of anthracene-9,10-dicarboxylic acid, C₁-C₁₀-alkyl esters of anthracene-9,10-dicarboxylic acid, C₁-C₁₀-alkenyl esters of anthracene-9,10-dicarboxylic acid, biphenyl-4,4′-dicarboxylic acid, biphenyl-4,4′-dicarboxylic anhydride, biphenyl-4,4′-dicarbonyl difluoride, biphenyl-4,4′-dicarbonyl dichloride, biphenyl-4,4′-dicarbonyl dibromide, polyanhydrides of biphenyl-4,4′-dicarboxylic acid, C₁-C₁₀-alkyl esters of biphenyl-4,4′-dicarboxylic acid, C₁-C₁₀-alkenyl esters of biphenyl-4,4′-dicarboxylic acid, diphenylmethane-4,4′-dicarboxylic acid, diphenylmethane-4,4′-dicarboxylic anhydride, diphenylmethane-4,4′-dicarbonyl difluoride, diphenylmethane-4,4′-dicarbonyl dichloride, diphenylmethane-4,4′-dicarbonyl dibromide, polyanhydrides of diphenylmethane-4,4′-dicarboxylic acid, C₁-C₁₀-alkyl esters of diphenylmethane-4,4′-dicarboxylic acid, C₁-C₁₀-alkenyl esters of diphenylmethane-4,4′-dicarboxylic acid, diphenyl ether 4,4′-dicarboxylic acid, diphenyl ether 4,4′-dicarboxylic anhydride, diphenyl ether 4,4′-dicarbonyl difluoride, diphenyl ether 4,4′-dicarbonyl dichloride, diphenyl ether 4,4′-dicarbonyl dibromide, polyanhydrides of diphenyl ether 4,4′-dicarboxylic acid, C₁-C₁₀-alkyl esters of diphenyl ether 4,4′-dicarboxylic acid, C₁-C₁₀-alkenyl esters of diphenyl ether 4,4′-dicarboxylic acid, diphenyl thioether 4,4′-dicarboxylic acid, diphenyl thioether 4,4′-dicarboxylic anhydride, diphenyl thioether 4,4′-dicarbonyl difluoride, diphenyl thioether 4,4′-dicarbonyl dichloride, diphenyl thioether 4,4′-dicarbonyl dibromide, polyanhydrides of diphenyl thioether 4,4′-dicarboxylic acid, C₁-C₀₀-alkyl esters of diphenyl thioether 4,4′-dicarboxylic acid, C₁-C₁₀-alkenyl esters of diphenyl thioether 4,4′-dicarboxylic acid, diphenyl sulfone 4,4′-dicarboxylic acid, diphenyl sulfone 4,4′-dicarboxylic anhydride, diphenyl sulfone 4,4′-dicarbonyl difluoride, diphenyl sulfone 4,4′-dicarbonyl dichloride, diphenyl sulfone 4,4′-dicarbonyl dibromide, polyanhydrides of diphenyl sulfone 4,4′-dicarboxylic acid, C₁-C₁₀-alkyl esters of diphenyl sulfone 4,4′-dicarboxylic acid, C₁-C₁₀-alkenyl esters of diphenyl sulfone 4,4′-dicarboxylic acid, benzophenone-4,4′-dicarboxylic acid, benzophenone-4,4′-dicarboxylic anhydride, benzophenone-4,4′-dicarbonyl difluoride, benzophenone-4,4′-dicarbonyl dichloride, benzophenone-4,4′-dicarbonyl dibromide, polyanhydrides of benzophenone-4,4′-dicarboxylic acid, C₁-C₁₀-alkyl esters of benzophenone-4,4′-dicarboxylic acid, C₁-C₁₀-alkenyl esters of benzophenone-4,4′-dicarboxylic acid, pyridine-2,5-dicarboxylic acid, pyridine-2,5-dicarboxylic anhydride, pyridine-2,5-dicarbonyl difluoride, pyridine-2,5-dicarbonyl dichloride, pyridine-2,5-dicarbonyl dibromide, polyanhydrides of pyridine-2,5-dicarboxylic acid, C₁-C₁₀-alkyl esters of pyridine-2,5-dicarboxylic acid, C₁-C₁₀-alkenyl esters of pyridine-2,5-dicarboxylic acid, pyrimidine-4,6-dicarboxylic acid, pyrimidine-4,6-dicarboxylic anhydride, pyrimidine-4,6-dicarbonyl difluoride, pyrimidine-4,6-dicarbonyl dichloride, pyrimidine-4,6-dicarbonyl dibromide, polyanhydrides of pyrimidine-4,6-dicarboxylic acid, C₁-C₁₀-alkyl esters of pyrimidine-4,6-dicarboxylic acid, C₁-C₁₀-alkenyl esters pyrimidine-4,6-dicarboxylic acid, furan-2,5-dicarboxylic acid, furan-2,5-dicarboxylic anhydride, furan-2,5-dicarbonyl difluoride, furan-2,5-dicarbonyl dichloride, furan-2,5-dicarbonyl dibromide, polyanhydrides of furan-2,5-dicarboxylic acid, C₁-C₁₀-alkyl esters of furan-2,5-dicarboxylic acid, C₁-C₁₀-alkenyl esters of furan-2,5-dicarboxylic acid, thiophene-2,5-dicarboxylic acid, thiophene-2,5-dicarboxylic anhydride, thiophene-2,5-dicarbonyl difluoride, thiophene-2,5-dicarbonyl dichloride, thiophene-2,5-dicarbonyl dibromide, polyanhydrides of thiophene-2,5-dicarboxylic acid, C₁-C₁₀-alkyl esters of thiophene-2,5-dicarboxylic acid and C₁-C₁₀-alkenyl esters of thiophene-2,5-dicarboxylic acid.

4: The method according to claim 1, wherein component (b) is selected from the group consisting of 4,6-diamino-1,3-dihydroxybenzene, 4,6-diamino-1,3-dithiobenzene, 4,6-diamino-3-hydroxy-1-thiobenzene, 2,5-diamino-1,4-dihydroxybenzene, 2,5-diamino-1,4-dithiobenzene, 2,5-diamino-4-hydroxy-1-thiobenzene, 4,6-diamino-1,3-dihydroxybenzene dihydrochloride, 4,6-diamino-1,3-dithiobenzene dihydrochloride, 4,6-diamino-3-hydroxy-1-thiobenzene dihydrochloride, 2,5-diamino-1,4-dihydroxybenzene dihydrochloride, 2,5-diamino-1,4-dithiobenzene dihydrochloride, 2,5-diamino-4-hydroxy-1-thiobenzne dihydrochloride, 3,3′-diamino-4,4′-dihydroxybiphenyl, 3,3′-diamino-4,4′-dihydroxybiphenyl dihydrochloride, 4,4′-diamino-3,3′-dihydroxybiphenyl, 4,4′-diamino-3,3′-dihydroxybiphenyl dihydrochloride, 3,3′-diamino-4,4′-dihydroxydiphenylmethane, 3,3′-diamino-4,4′-dihydroxydiphenylmethane dihydrochloride, 4,4′-diamino-3,3′-dihydroxydiphenylmethane and 4,4′-diamino-3,3′-dihydroxydiphenylmethane dihydrochloride.

5: The method according to claim 1, wherein the reaction mixture (R_{G}) comprises 5 to 25% by weight of component (a), 5 to 25% by weight of component (b) and 50 to 90% by weight of component (c), based on a total weight of the reaction mixture (R_{G}).

6: The method according to claim 1, wherein the at least one ionic liquid (IL) has formula (III):
[C]ₙ⁺[A]ⁿ⁻ (III)
in which
n=1, 2, 3 or 4;
the cation [C]ₙ⁺ is at least one cation selected from the group consisting of unsubstituted or at least monosubstituted imidazolium cations, imidazolinium cations, imidazolidinium cations, quaternary ammonium cations, quaternary phosphonium cations, pyrazolium cations, pyrazolinium cations, pyridinium cations, pyridazinium cations, pyrimidinium cations, pyrazinium cations, pyrrolidinium cations, guanidinium cations, thiazolium cations, oxazolium cations, triazolium cations, the 1,8-diazabicyclo[5.4.0]undec-7-enium cation, the 1,8-diazabicyclo[4.3.0]non-5-enium cation and oligomers or polymers comprising these cations,
wherein the substituents are selected from the group consisting of linear or branched —C₁-C₁₈-alkyl, —C₅-C₁₂-cycloalkyl and —C₆-C₁₄-aryl;
the anion [A]ⁿ⁻ is selected from the group consisting of halide-containing anions, cyanide, thiocyanate, cyanate, isocyanate, nitrite, nitrate, unsubstituted or at least monosubstituted sulfates, sulfites, sulfonates, carboxylates, borates, boronates, carbonates, carbonate esters, amides, carboximidates, sulfonyl imidates, bis(sulfonyl) imidates, alkoxides and aryl oxides,
wherein the substituents are selected from the group consisting of linear or branched —C₁-C₁₈-alkyl, —C₅-C₁₂-cycloalkyl and —C₆-C₁₄-aryl.

7: The method according to claim 6, wherein the at least one ionic liquid (IL) comprises at least one imidazolium cation of formula (IV) as cation [C]ₙ⁺: 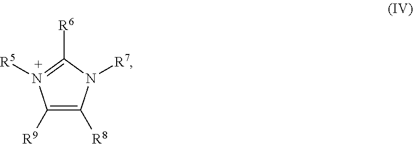
in which
R⁵, R⁶, R⁷, R⁸, R⁹ are each independently selected from the group consisting of —H, linear or branched —C₁-C₁₈-alkyl, —C₅-C₁₂-cycloalkyl and —C₆-C₁₄-aryl.

8: The method according to claim 6, wherein the cation [C]ₙ⁺ is at least one cation selected from the group consisting of 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methylimidazolium, 1-ethyl-3-methylimidazolium, 1-ethyl-2,3-dimethylimidazolium, 2-ethyl-3,4-dimethylimidazolium, 1-propylimidazolium, 1-propyl-2-methylimidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethylimidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium and 1-benzyl-3-methylimidazolium.

9: The method according to claim 1, wherein the at least one ionic liquid (IL) is selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, 1-methylimidazolium hydrogensulfate, 1-ethylimidazolium hydrogensulfate, 1-butylimidazolium hydrogensulfate, 1-butyl-3-methylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1,3-diethylimidazolium methanesulfonate, 1-butylimidazolium methanesulfonate, 1-butyl-3-methylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1,3-diethylimidazolium acetate, 1-butylimidazolium acetate, 1-butyl-3-methylimidazolium acetate, 1,3-dibutylimidazolium acetate, 1,3-dimethylimidazolium methylcarbonate, 1-ethyl-3-methylimidazolium methylcarbonate, 1-butyl-3-methylimidazolium methylcarbonate and 1-butyl-2,3-dimethylimidazolium methylcarbonate.

10: The method according to claim 1, wherein the reaction mixture (R_{G}) is reacted in the presence of at least one basic compound selected from the group consisting of lithium hydroxide, sodium hydroxide, potassium hydroxide, magnesium hydroxide, calcium hydroxide, barium hydroxide, lithium carbonate, sodium carbonate, potassium carbonate, magnesium carbonate, calcium carbonate, lithium hydride, sodium hydride, potassium hydride, magnesium hydride and calcium hydride.

11: The method according to claim 1, wherein at least 40% by weight of the polybenzazole polymer (P) is dissolved in the at least one ionic liquid (IL), based on a total weight of the polybenzazole polymer (P) in the product mixture (P_{G}).

12: A polybenzazole polymer (P) produced by the method according to claim 1.

13: The polybenzazole polymer (P) according to claim 12, wherein a content of sulfur-containing or phosphorus-containing acids in the polybenzazole polymer (P) is less than 1000 ppm.

14: Fiber material comprising the polybenzazole polymer (P) according to claim 12.
